(19) United States
(12) Patent Application Publication
(10) Pub. No.: US 2025/0285576 A1
(43) Pub. Date: Sep. 11, 2025

(54) DISPLAY APPARATUS, ELECTRONIC APPARATUS INCLUDING THE SAME AND A METHOD OF DRIVING A DISPLAY PANEL USING THE SAME

(71) Applicant: SAMSUNG DISPLAY CO., LTD., YONGIN-SI (KR)

(72) Inventors: KANGHEE LEE, Yongin-si (KR); HYUNGJIN KIM, Yongin-si (KR); JONG-WOONG PARK, Yongin-si (KR); KYUNGSU LEE, Yongin-si (KR); SEOKHA HONG, Yongin-si (KR)

(21) Appl. No.: 19/004,613

(22) Filed: Dec. 30, 2024

(30) Foreign Application Priority Data
Mar. 6, 2024 (KR) 10-2024-0032231

(51) Int. Cl. G09G 3/20

(52) U.S. Cl. CPC G09G 3/2096; G09G 2320/0257; G09G 2320/045; G09G 2320/068; G09G 2358/00

(57) ABSTRACT

A display apparatus including: a display panel including a viewing angle control pixel and a normal pixel; a data driver configured to output a data voltage to the display panel; and a driving controller configured to control the data driver, wherein the driving controller includes: a subpixel renderer configured to render input image data to the viewing angle control pixel and the normal pixel according to an operation mode; and an afterimage compensator configured to accumulate a first stress corresponding to the viewing angle control pixel to generate a first age of the viewing angle control pixel, accumulate a second stress corresponding to the normal pixel to generate a second age of the normal pixel, compensate data for the viewing angle control pixel based on the first age and compensate data for the normal pixel based on the second age.

### CROSS-REFERENCE TO RELATED APPLICATION

This application claims priority under 35 U.S.C. § 119 to Korean Patent Application No. 10-2024-0032231, filed on Mar. 6, 2024 in the Korean Intellectual Property Office KIPO, the disclosure of which is incorporated by reference herein in its entirety.

### 1. TECHNICAL FIELD

Embodiments of the present inventive concept relate to a display apparatus, an electronic apparatus including the display apparatus and a method of driving a display panel using the display apparatus. More particularly, embodiments of the present inventive concept relate to a display apparatus that enhances display quality by managing stress accumulation and deterioration compensation separately for viewing angle control pixels and normal pixels, an electronic apparatus including the display apparatus, and a method of driving a display panel using the display apparatus.

### 2. DESCRIPTION OF THE RELATED ART

Generally, a display apparatus includes a display panel and a display panel driver. The display panel includes a plurality of gate lines, a plurality of data lines and a plurality of pixels. The display panel driver includes a gate driver, a data driver and a driving controller. The gate driver outputs gate signals to the gate lines. The data driver outputs data voltages to the data lines. The driving controller manages the operations of both the gate driver and the data driver.

The display panel may include a viewing angle control pixel (referred to as a private pixel) which appears dimmer when viewed from the side compared to the front, enabling a private mode. In the private mode, an image of the display panel may be clearly visible from the front, but obscured from the side.

In the private mode, only the viewing angle control pixels (the private pixels) emit light, while the normal pixels do not. In contrast, in a normal mode, both the viewing angle control pixels and normal pixels emit light.

The viewing angle control pixels emit light in both the normal and private modes, while the normal pixels emit light in only the normal mode. This difference in operation can lead to varying levels of deterioration between the viewing angle control pixels and the normal pixels.

This difference in deterioration between the viewing angle control pixels and the normal pixels can degrade the overall display quality of the panel.

### SUMMARY

Embodiments of the present inventive concept provide a display apparatus that enhances display quality by independently managing stress accumulation and deterioration compensation for viewing angle control pixels and normal pixels.

Embodiments of the present inventive concept provide an electronic apparatus including the display apparatus.

Embodiments of the present inventive concept also provide a method of driving a display panel using the display apparatus.

According to an embodiment of the inventive concept, there is provided a display apparatus including: a display panel including a viewing angle control pixel and a normal pixel; a data driver configured to output a data voltage to the display panel; and a driving controller configured to control the data driver, wherein the driving controller includes: a subpixel renderer configured to render input image data to the viewing angle control pixel and the normal pixel according to an operation mode; and an afterimage compensator configured to accumulate a first stress corresponding to the viewing angle control pixel to generate a first age of the viewing angle control pixel, accumulate a second stress corresponding to the normal pixel to generate a second age of the normal pixel, compensate data for the viewing angle control pixel based on the first age and compensate data for the normal pixel based on the second age.

The afterimage compensator includes: a deterioration compensator configured to receive rendered image data and a flag signal from the subpixel renderer and output a deterioration compensation image data and the flag signal; and a stress accumulator configured to accumulate the first stress of the deterioration compensation image data for the viewing angle control pixel to generate the first age when the flag signal has a first value and accumulate the second stress of the deterioration compensation image data for the normal pixel to generate the second age when the flag signal has a second value, and wherein the deterioration compensator is configured to compensate the rendered image data for the viewing angle control pixel based on the first age and compensate the rendered image data for the normal pixel based on the second age.

The stress accumulator includes: a first stress encoder configured to generate the first stress from the deterioration compensation image data for the viewing angle control pixel when the flag signal has the first value; a first stress accumulator configured to accumulate the first stress to a previous first age to generate a current first age when the flag signal has the first value; a second stress encoder configured to generate the second stress from the deterioration compensation image data for the normal pixel when the flag signal has the second value; a second stress accumulator configured to accumulate the second stress to a previous second age to generate a current second age when the flag signal has the second value; and a stress memory configured to output the previous first age to the first stress accumulator, receive the current first age from the first stress accumulator, output the previous second age to the second stress accumulator and receive the current second age from the second stress accumulator.

The display apparatus further includes a nonvolatile memory configured to output the first age and the second age to the stress memory and receive the first age and the second age from the stress memory.

The deterioration compensator includes: a first deterioration amount calculator configured to receive the first age from the stress memory and calculate a first deterioration amount based on the first age; a first block interpolator configured to adjust the first deterioration amount using a first adjacent block deterioration amount of adjacent blocks to generate a first adjusted deterioration amount; a second deterioration amount calculator configured to receive the second age from the stress memory and calculate a second deterioration amount based on the second age; a second block interpolator configured to adjust the second deterioration amount using a second adjacent block deterioration amount of the adjacent blocks to generate a second adjusted deterioration amount; and a compensator configured to compensate the rendered image data for the viewing angle control pixel based on the first adjusted deterioration amount and compensate the rendered image data for the normal pixel based on the second adjusted deterioration amount.

The first stress, the second stress, the first age, the second age, the first deterioration amount, the second deterioration amount, the first adjusted deterioration amount and the second adjusted deterioration amount are generated in a unit of a block.

The deterioration compensator includes: a first deterioration amount calculator configured to receive the first age from the stress memory and calculate a first deterioration amount based on the first age; a second deterioration amount calculator configured to receive the second age from the stress memory and calculate a second deterioration amount based on the second age; and a compensator configured to compensate the rendered image data for the viewing angle control pixel based on the first deterioration amount and compensate the rendered image data for the normal pixel based on the second deterioration amount.

The first stress, the second stress, the first age, the second age, the first deterioration amount and the second deterioration amount are generated in a unit of a pixel.

The afterimage compensator includes: a deterioration compensator configured to receive rendered image data and a flag signal from the subpixel renderer and output deterioration compensation image data; and a stress accumulator configured to accumulate the first stress of the rendered image data for the viewing angle control pixel to generate the first age when the flag signal has a first value and accumulate the second stress of the rendered image data for the normal pixel to generate the second age when the flag signal has a second value, and wherein the deterioration compensator is configured to compensate the rendered image data for the viewing angle control pixel based on the first age and compensate the rendered image data for the normal pixel based on the second age.

The display panel includes: a first color first normal pixel disposed in a first pixel row; a second color 1-1 normal pixel and a second color 1-2 normal pixel sequentially disposed in a second pixel row; a first color first viewing angle control pixel, a third color first normal pixel and a first color second viewing angle control pixel sequentially disposed in a third pixel row; a second color 1-1 viewing angle control pixel, a second color 1-2 viewing angle control pixel, a second color 2-1 viewing angle control pixel and a second color 2-2 viewing angle control pixel sequentially disposed in a fourth pixel row; a third color first viewing angle control pixel, a first color second normal pixel and a third color second viewing angle control pixel sequentially disposed in a fifth pixel row; a second color 2-1 normal pixel and a second color 2-2 normal pixel sequentially disposed in a sixth pixel row; and a third color second normal pixel disposed in a seventh pixel row.

In a normal mode, the first color first normal pixel, the second color 1-1 normal pixel, the second color 1-2 normal pixel, the third color first normal pixel, the first color second normal pixel, the second color 2-1 normal pixel, the second color 2-2 normal pixel and the third color second normal pixel are configured to emit light, in the normal mode, the first color first viewing angle control pixel, the second color 1-1 viewing angle control pixel, the second color 1-2 viewing angle control pixel, the third color first viewing angle control pixel, the first color second viewing angle control pixel, the second color 2-1 viewing angle control pixel, the second color 2-2 viewing angle control pixel and the third color second viewing angle control pixel are configured to emit light, in a private mode, the first color first normal pixel, the second color 1-1 normal pixel, the second color 1-2 normal pixel, the third color first normal pixel, the first color second normal pixel, the second color 2-1 normal pixel, the second color 2-2 normal pixel and the third color second normal pixel are configured not to emit light, and in the private mode, the first color first viewing angle control pixel, the second color 1-1 viewing angle control pixel, the second color 1-2 viewing angle control pixel, the third color first viewing angle control pixel, the first color second viewing angle control pixel, the second color 2-1 viewing angle control pixel, the second color 2-2 viewing angle control pixel and the third color second viewing angle control pixel are configured to emit light.

The display panel includes: a first color first normal pixel, a second color first normal pixel, a third color first normal pixel, a first color first viewing angle control pixel, a second color first viewing angle control pixel and a third color first viewing angle control pixel sequentially disposed in a first row; and a first color second normal pixel, a second color second normal pixel, a third color second normal pixel, a first color second viewing angle control pixel, a second color second viewing angle control pixel and a third color second viewing angle control pixel sequentially disposed in a second row.

In a normal mode, the first color first normal pixel, the second color first normal pixel, the third color first normal pixel, the first color second normal pixel, the second color second normal pixel and the third color second normal pixel are configured to emit light, in the normal mode, the first color first viewing angle control pixel, the second color first viewing angle control pixel, the third color first viewing angle control pixel, the first color second viewing angle control pixel, the second color second viewing angle control pixel and the third color second viewing angle control pixel are configured to emit light, in a private mode, the first color first normal pixel, the second color first normal pixel, the third color first normal pixel, the first color second normal pixel, the second color second normal pixel and the third color second normal pixel are configured not to emit light, and in the private mode, the first color first viewing angle control pixel, the second color first viewing angle control pixel, the third color first viewing angle control pixel, the first color second viewing angle control pixel, the second color second viewing angle control pixel and the third color second viewing angle control pixel are configured to emit light.

According to an embodiment of the inventive concept, there is provided an electronic apparatus including: a display panel including a viewing angle control pixel and a normal pixel; a data driver circuit configured to output a data voltage to the display panel; a driving controller circuit configured to control the data driver circuit; and a host configured to output compensated input image data and an input control signal to the driving controller circuit, wherein the host includes an afterimage compensator circuit configured to accumulate a first stress for the viewing angle control pixel to generate a first age of the viewing angle control pixel, accumulate a second stress for the normal pixel to generate a second age of the normal pixel and compensate data of the viewing angle control pixel based on the first age and data of the normal pixel based on the second age to generate deterioration compensation image data.

The host further includes: a first subpixel renderer circuit configured to render input image data to the viewing angle control pixel and the normal pixel according to an operation mode; and an inverse subpixel renderer circuit configured to perform inverse subpixel rendering to the deterioration compensation image data to generate the compensated input image data, and wherein the driving controller circuit includes a second subpixel renderer circuit configured to render the compensated input image data to the viewing angle control pixel and the normal pixel according to the operation mode.

The host further includes a first subpixel renderer circuit configured to render input image data to the viewing angle control pixel and the normal pixel according to an operation mode and output rendered image data and a flag signal to the afterimage compensator circuit, wherein the afterimage compensator circuit includes: a deterioration compensator circuit configured to receive the rendered image data and the flag signal from the first subpixel renderer circuit and output the deterioration compensation image data and the flag signal; and a stress accumulator circuit configured to accumulate the first stress of the deterioration compensation image data for the viewing angle control pixel to generate the first age when the flag signal has a first value and accumulate the second stress of the deterioration compensation image data for the normal pixel to generate the second age when the flag signal has a second value, and wherein the deterioration compensator circuit is configured to compensate the rendered image data for the viewing angle control pixel based on the first age and the rendered image data for the normal pixel based on the second age.

The host further includes a first subpixel renderer circuit configured to render input image data to the viewing angle control pixel and the normal pixel according to an operation mode and output rendered image data and a flag signal to the afterimage compensator circuit, wherein the afterimage compensator circuit includes: a deterioration compensator circuit configured to receive the rendered image data and the flag signal from the first subpixel renderer circuit and output the deterioration compensation image data; and a stress accumulator circuit configured to accumulate the first stress of the rendered image data for the viewing angle control pixel to generate the first age when the flag signal has a first value and accumulate the second stress of the rendered image data for the normal pixel to generate the second age when the flag signal has a second value, and wherein the deterioration compensator circuit is configured to compensate the rendered image data for the viewing angle control pixel based on the first age and the rendered image data for the normal pixel based on the second age.

The host further includes a first subpixel renderer circuit configured to render the deterioration compensation image data to the viewing angle control pixel and the normal pixel according to an operation mode and output rendered image data and a flag signal to the afterimage compensator circuit, wherein the afterimage compensator circuit includes: a deterioration compensator circuit configured to compensate the input image data according to the operation mode and output the deterioration compensation image data; and a stress accumulator circuit configured to accumulate the first stress of the deterioration compensation image data for the viewing angle control pixel to generate the first age when the flag signal has a first value and accumulate the second stress of the deterioration compensation image data for the normal pixel to generate the second age when the flag signal has a second value.

In a normal mode, the deterioration compensator circuit is configured to compensate the input image data for the viewing angle control pixel and the input image data for the normal pixel by combining the first age and the second age, and in a private mode, the deterioration compensator circuit is configured to compensate the input image data for the viewing angle control pixel using the first age.

The host further includes a first subpixel renderer circuit configured to render input image data to the viewing angle control pixel and the normal pixel according to an operation mode and output rendered image data and a flag signal to the afterimage compensator circuit, and wherein the afterimage compensator circuit includes: a deterioration compensator circuit configured to compensate the input image data according to the operation mode and output the deterioration compensation image data; and a stress accumulator circuit configured to accumulate the first stress of the input image data for the viewing angle control pixel to generate the first age when the flag signal has a first value and accumulate the second stress of the input image data for the normal pixel to generate the second age when the flag signal has a second value.

According to an embodiment of the inventive concept, there is provided a method of driving a display panel, the method including: rendering input image data to a viewing angle control pixel of the display panel and a normal pixel of the display panel according to an operation mode; accumulating a first stress associated with the viewing angle control pixel to generate a first age of the viewing angle control pixel; accumulating a second stress associated with the normal pixel to generate a second age of the normal pixel; compensating data of the viewing angle control pixel based on the first age; and compensating data of the normal pixel based on the second age.

According to an embodiment of the inventive concept, there is provided a smartphone including: a display apparatus including: a display panel including a viewing angle control pixel and a normal pixel; a data driver configured to output a data voltage to the display panel; and a driving controller configured to control the data driver, wherein the driving controller includes: a subpixel renderer configured to render input image data to the viewing angle control pixel and the normal pixel according to an operation mode; and an afterimage compensator configured to: accumulate a first stress corresponding to the viewing angle control pixel to generate a first age of the viewing angle control pixel, accumulate a second stress corresponding to the normal pixel to generate a second age of the normal pixel, compensate data for the viewing angle control pixel based on the first age, and compensate data for the normal pixel based on the second age.

According to the display apparatus, the electronic apparatus including the display apparatus and the method of driving the display panel using the display apparatus, stress accumulation and deterioration compensation are separately managed for viewing angle control pixels and normal pixels. This approach helps prevent deterioration in display quality due to the differences in deterioration levels between these pixel types.

Additionally, the accuracy of determining the deterioration levels of the viewing angle control pixels and normal pixels is improved, further enhancing the display quality of the display panel.

### BRIEF DESCRIPTION OF THE DRAWINGS

The above and other features of the present inventive concept will become more apparent by describing in detail embodiments thereof with reference to the accompanying drawings, in which:

FIG. 1 is a block diagram illustrating a display apparatus according to an embodiment of the present inventive concept;

FIG. 2 is a diagram illustrating pixels of a display panel of FIG. 1 in a normal mode;

FIG. 3 is a diagram illustrating the pixels of the display panel of FIG. 1 in a private mode;

FIG. 4 is a table illustrating a turned-on state and a turned-off state of a normal pixel and a viewing angle control pixel in the normal mode and the private mode;

FIG. 5 is a block diagram illustrating a driving controller and a host of FIG. 1;

FIG. 6 is a block diagram illustrating the driving controller of FIG. 5 and a nonvolatile memory;

FIG. 7A is a detailed block diagram illustrating an example of the driving controller of FIG. 5 and the nonvolatile memory;

FIG. 7B is a detailed block diagram illustrating an example of the driving controller of FIG. 5 and the nonvolatile memory;

FIG. 8 is a block diagram illustrating a driving controller and a nonvolatile memory of a display apparatus according to an embodiment of the present inventive concept;

FIG. 9 is a block diagram illustrating a driving controller and a host of a display apparatus according to an embodiment of the present inventive concept;

FIG. 10 is a block diagram illustrating the host of FIG. 9 and a nonvolatile memory;

FIG. 11 is a block diagram illustrating a host and a nonvolatile memory of a display apparatus according to an embodiment of the present inventive concept;

FIG. 12 is a block diagram illustrating a host and a nonvolatile memory of a display apparatus according to an embodiment of the present inventive concept;

FIG. 13A is a diagram illustrating a first accumulation map of a stress accumulator of FIG. 12;

FIG. 13B is a diagram illustrating a second accumulation map of the stress accumulator of FIG. 12;

FIG. 13C is a diagram illustrating a first compensation map of a deterioration compensator of FIG. 12;

FIG. 14 is a block diagram illustrating a host and a nonvolatile memory of a display apparatus according to an embodiment of the present inventive concept;

FIG. 15 is a diagram illustrating pixels of a display panel of a display apparatus according to an embodiment of the present inventive concept in a normal mode;

FIG. 16 is a diagram illustrating pixels of the display panel of FIG. 15 in a private mode;

FIG. 17 is a block diagram illustrating an electronic apparatus according to an embodiment of the present inventive concept;

FIG. 18 is a diagram illustrating an example in which the electronic apparatus of FIG. 17 is implemented as a smartphone; and

FIG. 19 is a block diagram illustrating an electronic apparatus according to an embodiment of the present inventive concept.

### DETAILED DESCRIPTION OF THE INVENTIVE CONCEPT

Hereinafter, the present inventive concept will be explained in detail with reference to the accompanying drawings.

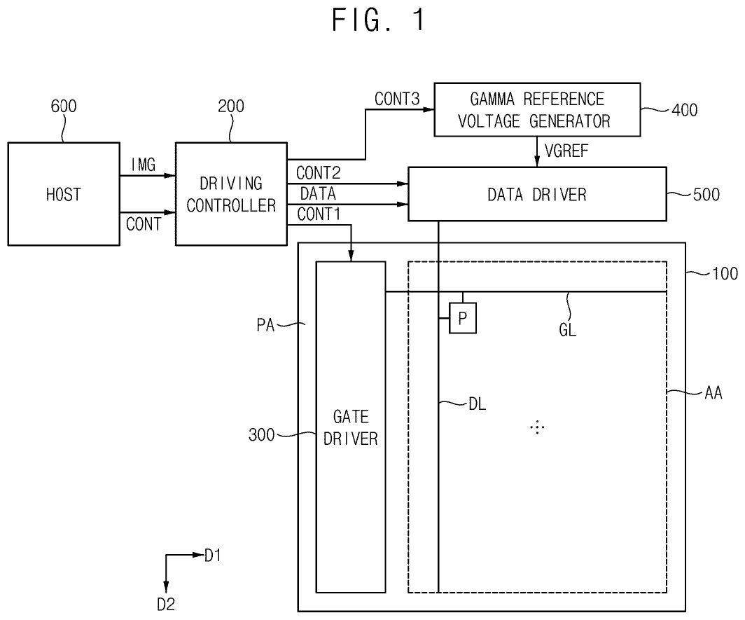

FIG. 1 is a block diagram illustrating a display apparatus according to an embodiment of the present inventive concept.

Referring to FIG. 1, the display apparatus includes a display panel 100 and a display panel driver. The display panel driver drives the display panel 100. The display panel driver includes a driving controller 200, a gate driver 300, a gamma reference voltage generator 400 and a data driver 500. The display panel driver may further include a host 600. For example, the host 600 may be an application processor.

Although it is described that the host 600 is included in the display apparatus in the present embodiment, the host 600 may be an external apparatus of the display apparatus.

For example, the driving controller 200 and the data driver 500 may be integrally formed. For example, the driving controller 200, the gamma reference voltage generator 400 and the data driver 500 may be integrally formed. A driving module including at least the driving controller 200 and the data driver 500 which are integrally formed may be referred to as a timing controller embedded data driver (TED).

The display panel 100 has a display region AA on which an image is displayed and a peripheral region PA adjacent to the display region AA.

The display panel 100 includes a plurality of gate lines GL, a plurality of data lines DL and a plurality of pixels P connected to the gate lines GL and the data lines DL. The gate lines GL may extend in a first direction D1 and the data lines DL may extend in a second direction D2 crossing the first direction D1.

The driving controller 200 receives input image data IMG and an input control signal CONT from the host 600. For example, the input image data IMG may include red image data, green image data and blue image data. For example, the input image data IMG may include white image data. For example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals driving the gate lines GL in response to the first control signal CONT1 received from the driving controller 200. The gate driver 300 outputs the gate signals to the gate lines GL. For example, the gate driver 300 may sequentially output the gate signals to the gate lines GL. For example, the gate driver 300 may be mounted on the peripheral region PA of the display panel 100. For example, the gate driver 300 may be integrated on the peripheral region PA of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into analog data voltages using the gamma reference voltages VGREF. The data driver 500 outputs the data voltages to the data lines DL.

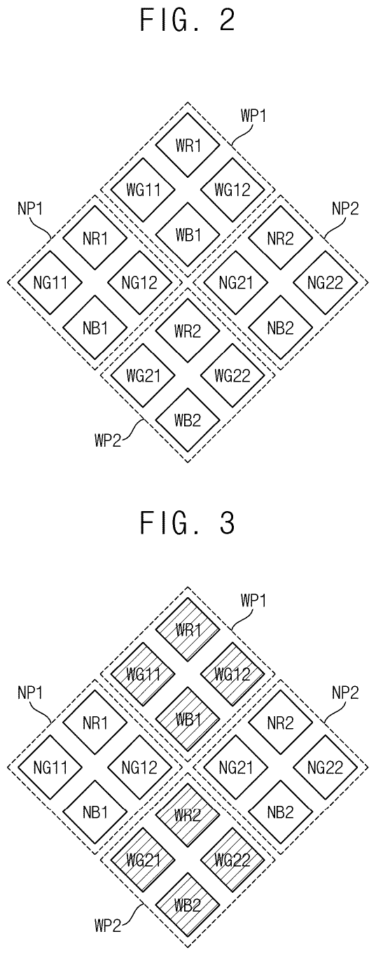

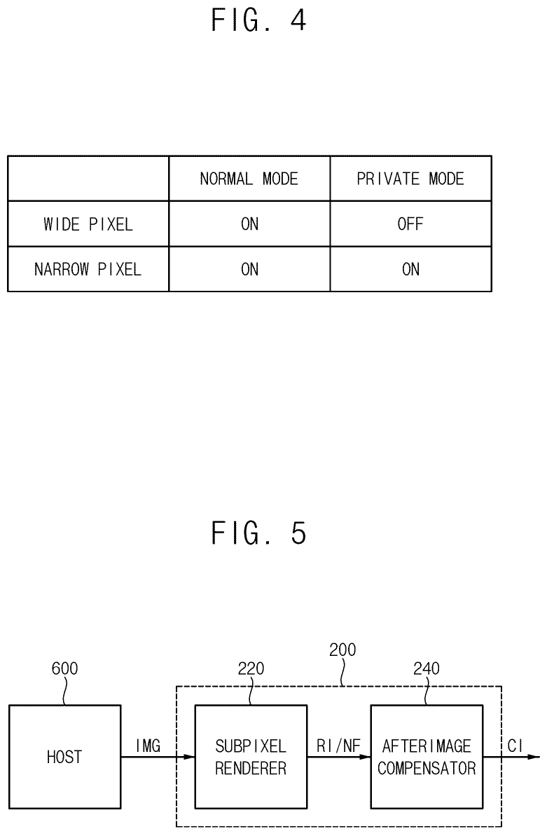

FIG. 2 is a diagram illustrating pixels of the display panel 100 of FIG. 1 in a normal mode. FIG. 3 is a diagram illustrating the pixels of the display panel 100 of FIG. 1 in a private mode. FIG. 4 is a table illustrating a turned-on state and a turned-off state of a normal pixel and a viewing angle control pixel in the normal mode and the private mode. In other words, FIG. 4 is a table illustrating the on and off states of a normal pixel and a viewing angle control pixel in both the normal mode and the private mode.

Referring to FIGS. 1 to 4, the display panel 100 may include a normal pixel and a viewing angle control pixel (e.g., a private pixel). The viewing angle control pixel, used in the private mode, may be referred to as a private or narrow pixel. The normal pixel may be referred to as a wide pixel.

The luminance of the viewing angle control pixel, as seen from the side, may be lower than the luminance perceived from the front. For example, the viewing angle control pixel may include a light-blocking pattern positioned on the light-emitting area. This pattern causes the side luminance to appear lower than the front luminance.

As shown in FIG. 4, in the private mode PRIVATE MODE, only the viewing angle control pixels NARROW PIXELs emit light, while the normal pixels WIDE PIXELs do not. This configuration allows the image of the display panel 100 to be clearly perceived from the front, but obscured from the side, thereby protecting the user's privacy. In contrast, in the normal mode NORMAL MODE, the viewing angle control pixels NARROW PIXELs and the normal pixels WIDE PIXELs may emit light.

Although only the viewing angle control pixels NARROW PIXELs emit light and the normal pixels WIDE PIXELs do not emit light in the private mode PRIVATE MODE in FIG. 4, the present inventive concept may not be limited thereto. Alternatively, the viewing angle control pixels NARROW PIXELs and the normal pixels WIDE PIXELs may both emit light in the private mode PRIVATE MODE. In this case, the light emission intensity of the viewing angle control pixels NARROW PIXELs may be greater than that of the normal pixels WIDE PIXELS.

A front luminance of the normal pixel WIDE PIXEL as perceived by a user from the front may be substantially the same as that of the viewing angle control pixel NARROW PIXEL when viewed from the front. However, a side luminance of the normal pixel WIDE PIXEL as perceived from the side may be greater than that of the viewing angle control pixel NARROW PIXEL.

The front luminance of the normal pixel WIDE PIXEL may be substantially the same as the side luminance of the normal pixel WIDE PIXEL. In contrast, the front luminance of the viewing angle control pixel NARROW PIXEL may be greater than the side luminance of the viewing angle control pixel NARROW PIXEL. For example, the side luminance of the viewing angle control pixel NARROW PIXEL may be equal to or less than a half of the front luminance of the viewing angle control pixel NARROW PIXEL.

The display panel 100 may include a first color first normal pixel WR1 disposed in a first pixel row, a second color 1-1 normal pixel WG11 and a second color 1-2 normal pixel WG12 sequentially disposed in a second pixel row, a first color first viewing angle control pixel NR1, a third color first normal pixel WB1 and a first color second viewing angle control pixel NR2 sequentially disposed in a third pixel row, a second color 1-1 viewing angle control pixel NG11, a second color 1-2 viewing angle control pixel NG12, a second color 2-1 viewing angle control pixel NG21 and a second color 2-2 viewing angle control pixel NG22 sequentially disposed in a fourth pixel row, a third color first viewing angle control pixel NB1, a first color second normal pixel WR2 and a third color second viewing angle control pixel NB2 sequentially disposed in a fifth pixel row, a second color 2-1 normal pixel WG21 and a second color 2-2 normal pixel WG22 sequentially disposed in a sixth pixel row and a third color second normal pixel WB2 disposed in a seventh pixel row.

Herein, the first color is red, the second color is green and the third color is blue.

In FIGS. 2 and 3, the normal pixel refers to a light emitting area of the normal pixel and the viewing angle control pixel refers to a light emitting area of the viewing angle control pixel.

In the display panel 100, one light emitting area of a red pixel, one light emitting area of a blue pixel, and two light emitting areas of green pixels may be disposed in a diamond shape. For example, WR1, WG11, WG12 and WB1 may be disposed in a diamond shape. WR1, WG11, WG12 and WB1 may be one unit pixel group (a normal pixel group WP1). For example, NR1, NG11, NG12 and NB1 may be disposed in a diamond shape. NR1, NG11, NG12 and NB1 may be one unit pixel group (a viewing angle control pixel group NP1). For example, WR2, WG21, WG22 and WB2 may be disposed in a diamond shape. WR2, WG21, WG22 and WB2 may be one unit pixel group (a normal pixel group WP2). For example, NR2, NG21, NG22 and NB2 may be disposed in a diamond shape. NR2, NG21, NG22 and NB2 may be one unit pixel group (a viewing angle control pixel group NP2).

In the normal mode, the first color first normal pixel WR1, the second color 1-1 normal pixel WG11, the second color 1-2 normal pixel WG12, the third color first normal pixel WB1, the first color second normal pixel WR2, the second color 2-1 normal pixel WG21, the second color 2-2 normal pixel WG22 and the third color second normal pixel WB2 may emit light. In the normal mode, the first color first viewing angle control pixel NR1, the second color 1-1 viewing angle control pixel NG11, the second color 1-2 viewing angle control pixel NG12, the third color first viewing angle control pixel NB1, the first color second viewing angle control pixel NR2, the second color 2-1 viewing angle control pixel NG21, the second color 2-2 viewing angle control pixel NG22 and the third color second viewing angle control pixel NB2 may emit light.

In the private mode, the first color first normal pixel WR1, the second color 1-1 normal pixel WG11, the second color 1-2 normal pixel WG12, the third color first normal pixel WB1, the first color second normal pixel WR2, the second color 2-1 normal pixel WG21, the second color 2-2 normal pixel WG22 and the third color second normal pixel WB2 may not emit light. In other words, the first color first normal pixel WR1, the second color 1-1 normal pixel WG11, the second color 1-2 normal pixel WG12, the third color first normal pixel WB1, the first color second normal pixel WR2, the second color 2-1 normal pixel WG21, the second color 2-2 normal pixel WG22 and the third color second normal pixel WB2 may be turned-off in the private mode. In the private mode, the first color first viewing angle control pixel NR1, the second color 1-1 viewing angle control pixel NG11, the second color 1-2 viewing angle control pixel NG12, the third color first viewing angle control pixel NB1, the first color second viewing angle control pixel NR2, the second color 2-1 viewing angle control pixel NG21, the second color 2-2 viewing angle control pixel NG22 and the third color second viewing angle control pixel NB2 may emit light.

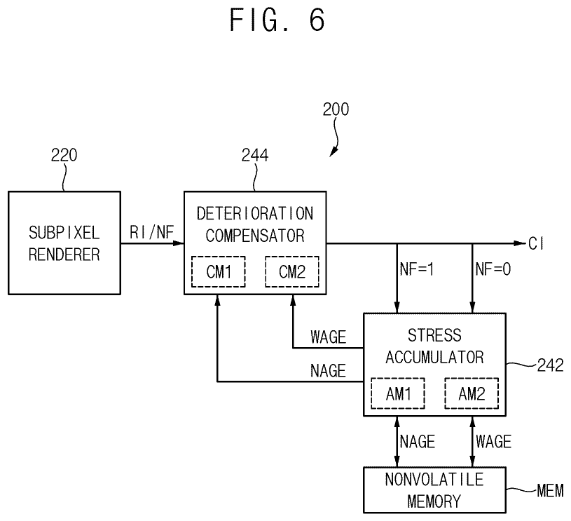

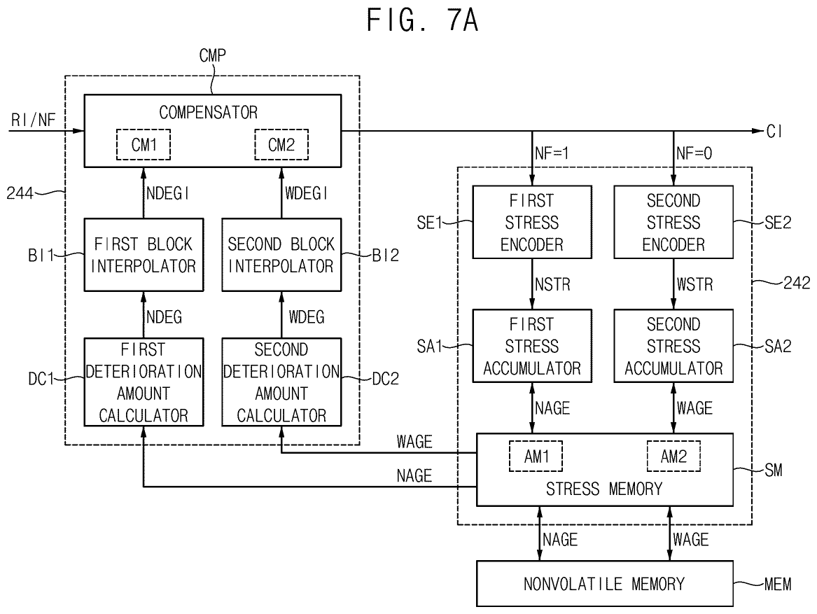

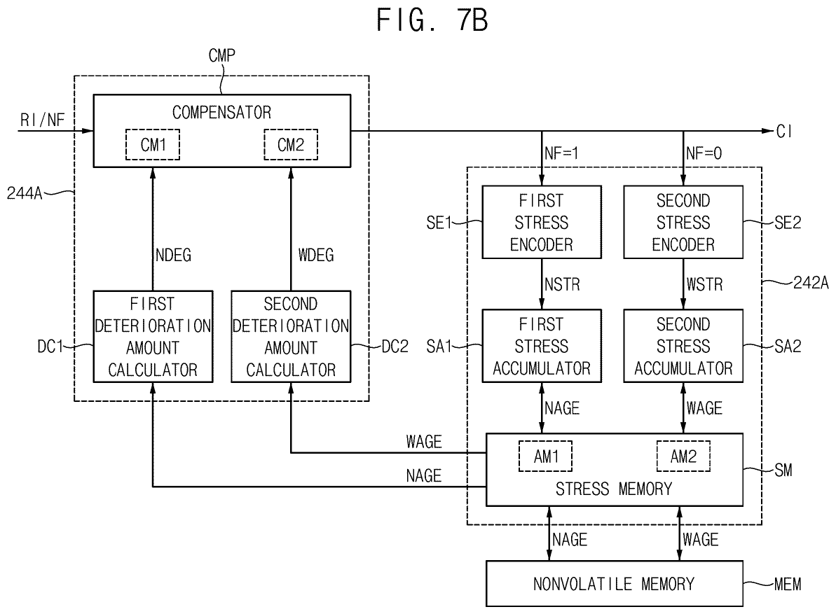

FIG. 5 is a block diagram illustrating the driving controller 200 and the host 600 of FIG. 1. FIG. 6 is a block diagram illustrating the driving controller 200 of FIG. 5 and a nonvolatile memory MEM. FIG. 7A is a detailed block diagram illustrating an example of the driving controller 200 of FIG. 5 and the nonvolatile memory MEM. Each component of the driving controller 200 may be implemented in hardware as a circuit.

Referring to FIGS. 1 to 7A, the driving controller 200 may include a subpixel renderer 220, which renders the input image data IMG to the viewing angle control pixel and the normal pixel according to the selected operation mode, and an afterimage compensator 240. The afterimage compensator 240 accumulates a first stress NSTR related to the viewing angle control pixel to generate a first age NAGE for the viewing angle control pixel and a second stress WSTR related to the normal pixel to generate a second age WAGE for the normal pixel. The afterimage compensator 240 that compensates the data of the viewing angle control pixel based on the first age NAGE and the data of the normal pixel based on the second age WAGE. Herein, the operation mode may include the normal mode and the private mode. Herein, the age is a value related to a lifespan of the pixel of the display panel 100 and may indicate an accumulated value of a stress of the pixel. In other words, “age” represents a value related to the pixel's lifespan reflecting the accumulated stress on the pixel. For example, as a grayscale value or luminance in a pixel results in higher stress.

The subpixel renderer 220 may operate the subpixel rendering such that a grayscale value of the normal pixel and a grayscale value of the viewing angle control pixel are substantially the same in the normal mode.

In contrast, the subpixel renderer 220 may operate the subpixel rendering such that the grayscale value of the viewing angle control pixel is greater than the grayscale value of the normal pixel in the private mode. For example, the subpixel renderer 220 may operate the subpixel rendering such that a luminance of the normal pixel in the private mode is zero and a luminance of the viewing angle control pixel in the private mode is twice a luminance of the viewing angle control pixel in the normal mode.

The afterimage compensator 240 may include a stress accumulator 242 and a deterioration compensator 244.

The deterioration compensator 244 may receive rendered image data RI and a flag signal NF from the subpixel renderer 220. The deterioration compensator 244 may output a deterioration compensation image data CI and the flag signal NF.

When the flag signal NF has a first value (e.g. NF=1), the stress accumulator 242 may accumulate the first stress NSTR of the deterioration compensation image data CI corresponding to the viewing angle control pixel to generate the first age NAGE.

When the flag signal NF has a second value (e.g. NF=0), the stress accumulator 242 may accumulate the second stress WSTR of the deterioration compensation image data CI corresponding to the normal pixel to generate the second age WAGE.

The deterioration compensator 244 may compensate the rendered image data RI corresponding to the viewing angle control pixel based on the first age NAGE and compensate the rendered image data RI corresponding to the normal pixel based on the second age WAGE.

For example, the stress accumulator 242 may include a first stress encoder SE1 that generates the first stress NSTR from the deterioration compensation image data CI corresponding to the viewing angle control pixel when the flag signal NF has the first value (e.g. NF=1), a first stress accumulator SA1 that accumulates the first stress NSTR with the previous first age to produce the current first age when the flag signal NF has the first value (e.g. NF=1), a second stress encoder SE2 that generates the second stress WSTR from the deterioration compensation image data CI corresponding to the normal pixel when the flag signal NF has the second value (e.g. NF=0), and a second stress accumulator SA2 that accumulates the second stress WSTR to the previous second age to produce the current second age when the flag signal NF has the second value (e.g. NF=0). A stress memory SM outputs the previous first age to the first stress accumulator SA1 and receives the current first age from the first stress accumulator SA1, while also outputting the previous second age to the second stress accumulator SA2 and receiving the current second age from the second stress accumulator SA2.

The display panel driver further includes the nonvolatile memory MEM that outputs the first age NAGE and the second age WAGE to the stress memory SM and receives the first age NAGE and the second age WAGE from the stress memory SM.

When the display apparatus is turned off, the first age NAGE and the second age WAGE of the stress memory SM may be saved to the nonvolatile memory MEM. In addition, the first NAGE and the second age WAGE may be periodically updated from the stress memory SM to the nonvolatile memory MEM in a predetermined cycle.

In addition, when the display apparatus is turned on, the first age NAGE and the second age WAGE of the nonvolatile memory MEM may be saved to the stress memory SM.

For example, the first age NAGE may form a first accumulation map AM1. For example, the second age WAGE may form a second accumulation map AM2.

For example, the deterioration compensator 244 may include a first deterioration amount calculator DC1 that receives the first age NAGE from the stress memory SM and calculates a first deterioration amount NDEG based on the first age NAGE, a first block interpolator BI1 that adjust the first deterioration amount NDEG using a first adjacent block deterioration amount of adjacent blocks to generate a first adjusted deterioration amount NDEGI, a second deterioration amount calculator DC2 that receives the second age WAGE from the stress memory SM and calculates a second deterioration amount WDEG based on the second age WAGE, and a second block interpolator BI2 that adjust the second deterioration amount WDEG using a second adjacent block deterioration amount of adjacent blocks to generate a second adjusted deterioration amount WDEGI. A compensator CMP then compensates the rendered image data RI for the viewing angle control pixel based on the first adjusted deterioration amount NDEGI and for the normal pixel based on the second adjusted deterioration amount WDEGI.

For example, the first block interpolator BI1 may determine a deterioration amount of a central pixel of a target block as the first deterioration amount NDEG. The first block interpolator BI1 may perform interpolation by adjusting the first deterioration amount NDEG of the target block using the first block deterioration amounts of blocks adjacent to the target block.

For example, the second block interpolator BI2 may determine a deterioration amount of a central pixel of a target block as the second deterioration amount WDEG. The second block interpolator BI2 may perform interpolation by adjusting the second deterioration amount WDEG of the target block using the second block deterioration amounts of blocks adjacent to the target block.

For example, the first adjusted deterioration amount NDEGI may form a first compensation map CM1. For example, the second adjusted deterioration amount WDEGI may form a second compensation map CM2.

The first deterioration amount NDEG and the second deterioration amount WDEG may represent a luminance deterioration rate which is a ratio of the current expected luminance to an initial luminance or a target luminance.

In the present embodiment, the stress accumulation and the deterioration compensation may be operated in a unit of a block. In other words, stress accumulation and deterioration compensation are performed on a block-by-block basis.

For example, the first stress NSTR, the second stress WSTR, the first age NAGE, the second age WAGE, the first deterioration amount NDEG, the second deterioration amount WDEG, the first adjusted deterioration amount NDEGI and the second adjusted deterioration amount WDEGI may be generated in a unit of the block. The block may include a plurality of adjacent pixels. The first stress NSTR, the second stress WSTR, the first age NAGE, the second age WAGE, the first deterioration amount NDEG, the second deterioration amount WDEG, the first adjusted deterioration amount NDEGI and the second adjusted deterioration amount WDEGI are generated in a unit of the block including the plurality of adjacent pixels so that a size of the stress memory SM and a size of the nonvolatile memory MEM may be reduced.

FIG. 7B is a detailed block diagram illustrating an example of the driving controller 200 of FIG. 5 and the nonvolatile memory MEM.

Unlike FIG. 7A, the stress accumulation and the deterioration compensation may be operated in a unit of a pixel in FIG. 7B.

For example, the stress accumulator 242A may include a first stress encoder SE1 that generates the first stress NSTR from the deterioration compensation image data CI for the viewing angle control pixel when the flag signal NF has the first value (e.g. NF=1), a first stress accumulator SA1 that adds the first stress NSTR to the previous first age to generate the current first age when the flag signal NF has the first value (e.g. NF=1), a second stress encoder SE2 that generates the second stress WSTR from the deterioration compensation image data CI for the normal pixel when the flag signal NF has the second value (e.g. NF=0), and a second stress accumulator SA2 that adds the second stress WSTR to the previous second age to generate the current second age when the flag signal NF has the second value (e.g. NF=0). A stress memory SM outputs the previous first age to the first stress accumulator SA1 and receives the current first age from the first stress accumulator SA1 and outputs the previous second age to the second stress accumulator SA2 and receives the current second age from the second stress accumulator SA2.

For example, the deterioration compensator 244A may include a first deterioration amount calculator DC1 that receives the first age NAGE from the stress memory SM and calculates a first deterioration amount NDEG based on the first age NAGE, a second deterioration amount calculator DC2 that receives the second age WAGE from the stress memory SM and calculates a second deterioration amount WDEG based on the second age WAGE and a compensator CMP that compensates the rendered image data RI for the viewing angle control pixel based on the first deterioration amount NDEG and the rendered image data RI for the normal pixel based on the second deterioration amount WDEG.

In the present embodiment, the first stress NSTR, the second stress WSTR, the first age NAGE, the second age WAGE, the first deterioration amount NDEG and the second deterioration amount WDEG may be generated in a unit of the pixel.

The first stress NSTR, the second stress WSTR, the first age NAGE, the second age WAGE and the first deterioration amount NDEG are generated in a unit of the pixel so that an accuracy of the deterioration compensation may be enhanced.

According to the present embodiment, stress accumulation and deterioration compensation are applied separately to the viewing angle control pixels and normal pixels to prevent display quality deterioration caused by differences in their respective deterioration levels.

Enhancing the accuracy of determining the deterioration levels (or degrees) of the viewing angle control pixels and the normal pixels further improves the overall display quality of the display panel 100.

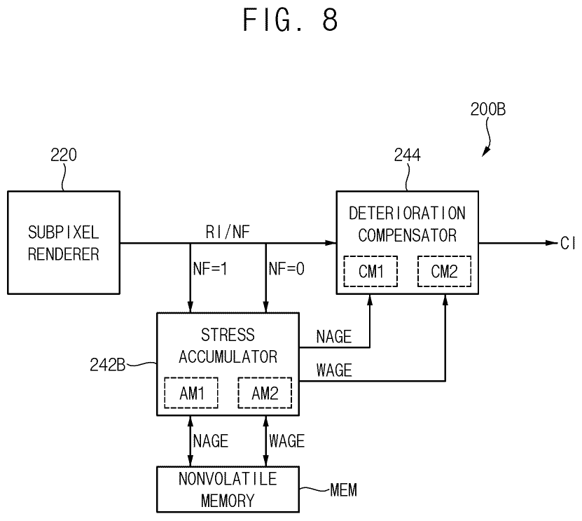

FIG. 8 is a block diagram illustrating a driving controller 200B and a nonvolatile memory MEM of a display apparatus according to an embodiment of the present inventive concept.

The display apparatus according to the present embodiment is substantially the same as the display apparatus of the previous embodiment explained referring to FIGS. 1 to 7B except that the stress accumulator does not accumulate the stress of the deterioration compensation image data but instead accumulates the stress of the rendered image data. Thus, the same reference numerals will be used to refer to the same or like parts as those described in the previous embodiment of FIGS. 1 to 7B and any repetitive explanation concerning the above elements will be omitted.

Referring to FIGS. 1 to 5, 7A, 7B and 8, the afterimage compensator 240 may include a deterioration compensator 244 and a stress accumulator 242B.

The deterioration compensator 244 may receive the rendered image data RI and the flag signal NF from the subpixel renderer 220 and may output the deterioration compensation image data CI.

When the flag signal NF has a first value (e.g. NF=1), the stress accumulator 242B may accumulate the first stress NSTR of the rendered image data RI for the viewing angle control pixel to generate the first age NAGE. When the flag signal NF has a second value (e.g. NF=0), the stress accumulator 242B may accumulate the second stress WSTR of the rendered image data RI for the normal pixel to generate the second age WAGE.

The deterioration compensator 244 may compensate the rendered image data RI for the viewing angle control pixel based on the first age NAGE and compensate the rendered image data RI for the normal pixel based on the second age WAGE.

In the present embodiment, detailed structures of the stress accumulator 242B and the deterioration compensator 244 may be substantially the same as detailed structures of the stress accumulator 242 and the deterioration compensator 244 explained referring to FIGS. 7A and 7B.

According to the present embodiment, stress accumulation and deterioration compensation are applied separately to the viewing angle control pixels and normal pixels to prevent display quality deterioration caused by differences in their respective deterioration levels.

Improving the accuracy in determining the deterioration levels of the viewing angle control pixels and the normal pixels further enhances the display quality of the display panel 100.

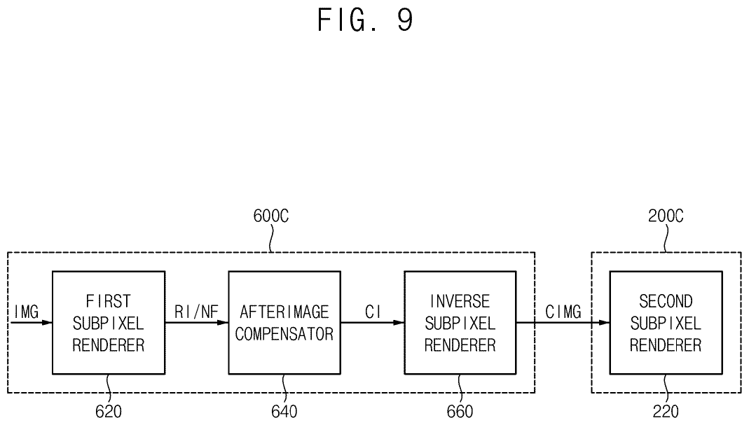

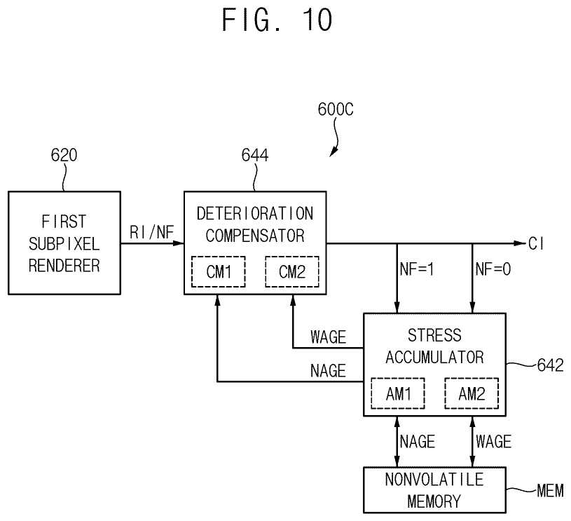

FIG. 9 is a block diagram illustrating a driving controller 200C and a host 600C of a display apparatus according to an embodiment of the present inventive concept. FIG. 10 is a block diagram illustrating the host 600C of FIG. 9 and a nonvolatile memory MEM.

The display apparatus according to the present embodiment is substantially the same as the display apparatus of the previous embodiment explained referring to FIGS. 1 to 7B except that the afterimage compensator is disposed in the host. Thus, the same reference numerals will be used to refer to the same or like parts as those described in the previous embodiment of FIGS. 1 to 7B and any repetitive explanation concerning the above elements will be omitted.

Referring to FIGS. 1 to 4, 7A, 7B, 9 and 10, the display apparatus includes a display panel 100, a data driver 500, a driving controller 200C and a host 600C. Like the driving controller 200 described above, each component of the host 600C may be implemented in hardware in a circuit.

The display apparatus includes the display panel 100 and a display panel driver. The display panel driver drives the display panel 100. The display panel driver includes the driving controller 200C, a gate driver 300, a gamma reference voltage generator 400 and the data driver 500. The display panel driver may further include the host 600C. The host 600C may be an application processor.

Although it is described that the host 600C is included in the display apparatus in the present embodiment, the host 600C may be an external apparatus of the display apparatus.

The host 600C outputs compensated input image data CIMG and an input control signal CONT to the driving controller 200C.

The host 600C may include an afterimage compensator 640 that accumulates a first stress NSTR for the viewing angle control pixel to generate a first age NAGE of the viewing angle control pixel and a second stress WSTR for the normal pixel to generate a second age WAGE of the normal pixel. The host 600C then compensates the data of the viewing angle control pixel based on the first age NAGE and the data of the normal pixel based on the second age WAGE to generate the deterioration compensation image data CI.

The host 600C may further include a first subpixel renderer 620 that renders input image data IMG to the viewing angle control pixel and the normal pixel according to an operation mode and an inverse subpixel renderer 660 that performs inverse subpixel rendering to the deterioration compensation image data CI to generate the compensated input image data CIMG. For example, the inverse subpixel renderer 660 may generate compensated input image data CIMG corresponding to MIPI (mobile industry processor interface), which is a data communication format between the host 600C and the driving controller 200C. However, the data communication format between the host 600C and the driving controller 200C may not be limited to the MIPI format in the present inventive concept.

In addition, the driving controller 200C may include a second subpixel renderer 220 that renders the compensated input image data CIMG to the viewing angle control pixel and the normal pixel according to the operation mode.

In the present embodiment, the first subpixel renderer 620 may render the input image data IMG to the viewing angle control pixel and the normal pixel according to the operation mode and output rendered image data RI and a flag signal NF to the afterimage compensator 640.

The afterimage compensator 640 may include a deterioration compensator 644 that receives the rendered image data RI and the flag signal NF from the first subpixel renderer 620 and outputs the deterioration compensation image data CI and the flag signal NF and a stress accumulator 642 that accumulates the first stress NSTR of the deterioration compensation image data CI for the viewing angle control pixel to generate the first age NAGE when the flag signal NF has a first value (e.g. NF=1) and the second stress WSTR of the deterioration compensation image data CI for the normal pixel to generate the second age WAGE when the flag signal NF has a second value (e.g. NF=0).

The deterioration compensator 644 may compensate the rendered image data RI for the viewing angle control pixel based on the first age NAGE and compensate the rendered image data RI for the normal pixel based on the second age WAGE.

In the present embodiment, detailed structures of the stress accumulator 642 and the deterioration compensator 644 may be substantially the same as detailed structures of the stress accumulator 242 and the deterioration compensator 244 explained referring to FIGS. 7A and 7B.

In the present embodiment, the first age NAGE may form a first accumulation map AM1 and the second age WAGE may form a second accumulation map AM2. In addition, the first adjusted deterioration amount (NDEGI in FIG. 7A) or the first deterioration amount (NDEG in FIG. 7B) may form a first compensation map CM1. For example, the second adjusted deterioration amount (WDEGI in FIG. 7A) or the second deterioration amount (WDEG in FIG. 7B) may form a second compensation map CM2.

According to the present embodiment, stress accumulation and deterioration compensation are independently applied to the viewing angle control pixels and normal pixels, helping to prevent display quality degradation resulting from differences in their deterioration levels.

Improving the accuracy in determining the deterioration levels of both the viewing angle control pixels and normal pixels further enhances the display quality of the display panel 100.

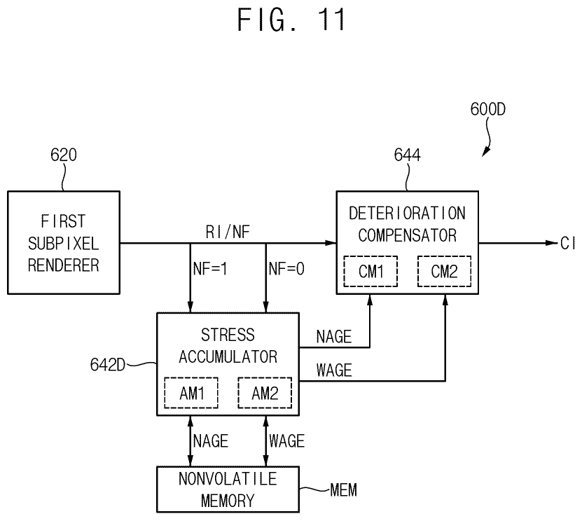

FIG. 11 is a block diagram illustrating a host 600D and a nonvolatile memory MEM of a display apparatus according to an embodiment of the present inventive concept.

The display apparatus according to the present embodiment is substantially the same as the display apparatus of the previous embodiment explained referring to FIGS. 9 and 10 except that the stress accumulator does not accumulate the stress of the deterioration compensation image data but instead accumulates the stress of the rendered image data. Thus, the same reference numerals will be used to refer to the same or like parts as those described in the previous embodiment of FIGS. 9 and 10 and any repetitive explanation concerning the above elements will be omitted.

Referring to FIGS. 1 to 4, 7A, 7B, 9 and 11, the display apparatus includes a display panel 100, a data driver 500, a driving controller 200C and a host 600D.

The host 600D outputs compensated input image data CIMG and an input control signal CONT to the driving controller 200C.

The host 600D may include an afterimage compensator 640 that accumulates a first stress NSTR for the viewing angle control pixel to generate a first age NAGE of the viewing angle control pixel, and a second stress WSTR for the normal pixel to generate a second age WAGE of the normal pixel. The host 600D then compensates data for the viewing angle control pixel based on the first age NAGE and for the normal pixel based on the second age WAGE to generate the deterioration compensation image data CI.

The host 600D may further include a first subpixel renderer 620 that renders input image data IMG to the viewing angle control pixel and the normal pixel according to an operation mode and an inverse subpixel renderer 660 that performs inverse subpixel rendering to the deterioration compensation image data CI to generate the compensated input image data CIMG.

In addition, the driving controller 200C may include a second subpixel renderer 220 that renders the compensated input image data CIMG to the viewing angle control pixel and the normal pixel according to the operation mode.

In the present embodiment, the first subpixel renderer 620 may render the input image data IMG to the viewing angle control pixel and the normal pixel according to the operation mode and output rendered image data RI and a flag signal NF to the afterimage compensator 640.

The afterimage compensator 640 may include a deterioration compensator 644 that receives the rendered image data RI and the flag signal NF from the first subpixel renderer 620 and outputs the deterioration compensation image data CI and a stress accumulator 642D that accumulates the first stress NSTR of the rendered image data RI for the viewing angle control pixel to generate the first age NAGE when the flag signal NF has a first value (e.g. NF=1) and the second stress WSTR of the rendered image data RI for the normal pixel to generate the second age WAGE when the flag signal NF has a second value (e.g. NF=0).

The deterioration compensator 644 may compensate the rendered image data RI for the viewing angle control pixel based on the first age NAGE and compensate the rendered image data RI for the normal pixel based on the second age WAGE.

In the present embodiment, detailed structures of the stress accumulator 642D and the deterioration compensator 644 may be substantially the same as detailed structures of the stress accumulator 242 and the deterioration compensator 244 explained referring to FIGS. 7A and 7B.

According to the present embodiment, stress accumulation and deterioration compensation are independently applied to the viewing angle control pixels and normal pixels, helping to prevent display quality degradation resulting from differences in their deterioration levels.

Improving the accuracy in determining the deterioration levels of both the viewing angle control pixels and normal pixels further enhances the display quality of the display panel 100.

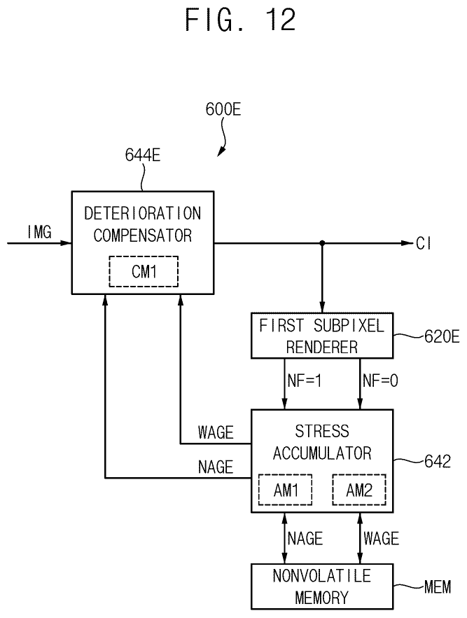

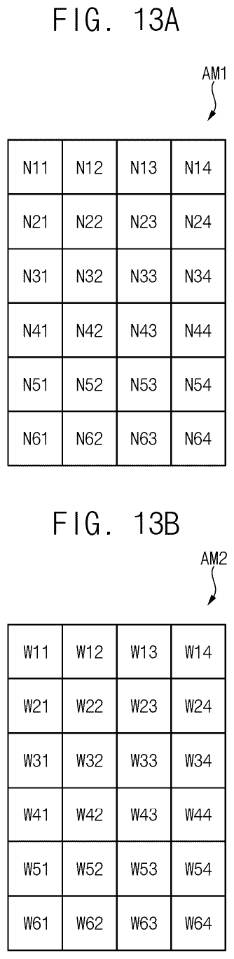

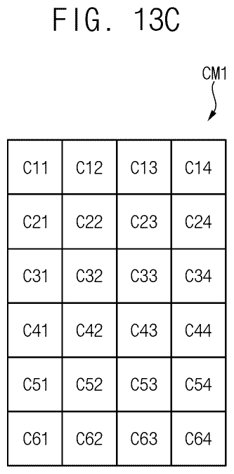

FIG. 12 is a block diagram illustrating a host 600E and a nonvolatile memory MEM of a display apparatus according to an embodiment of the present inventive concept. FIG. 13A is a diagram illustrating a first accumulation map AM1 of a stress accumulator 642 of FIG. 12. FIG. 13B is a diagram illustrating a second accumulation map AM2 of the stress accumulator 642 of FIG. 12. FIG. 13C is a diagram illustrating a first compensation map CM1 of a deterioration compensator 644E of FIG. 12.

The display apparatus according to the present embodiment is substantially the same as the display apparatus of the previous embodiment explained referring to FIGS. 9 and 10 except that a position of the first subpixel renderer is changed since the flag signal does not exist on a data path through which input image data and deterioration compensation image data pass. Thus, the same reference numerals will be used to refer to the same or like parts as those described in the previous embodiment of FIGS. 9 and 10 and any repetitive explanation concerning the above elements will be omitted.

Referring to FIGS. 1 to 4, 7A, 7B and 12 to 13C, the display apparatus includes a display panel 100, a data driver 500, a driving controller 200C and a host 600E.

In the present embodiment, the host 600E may include a first subpixel renderer 620E for rendering the deterioration compensation image data CI to the viewing angle control pixel and the normal pixel according to an operation mode and outputting rendered image data and a flag signal NF to the afterimage compensator (e.g. the stress accumulator 642).

In the present embodiment, the afterimage compensator may include a deterioration compensator 644E for compensating the input image data IMG according to the operation mode and outputting the deterioration compensation image data CI and a stress accumulator 642 for accumulating the first stress NSTR of the deterioration compensation image data CI corresponding to the viewing angle control pixel to generate the first age NAGE when the flag signal NF has a first value (e.g. NF=1) and accumulating the second stress WSTR of the deterioration compensation image data CI corresponding to the normal pixel to generate the second age WAGE when the flag signal NF has a second value (e.g. NF=0).

In the present embodiment, the deterioration compensator 644E may compensate the input image data IMG corresponding to the viewing angle control pixel and the input image data IMG corresponding to the normal pixel based on the first age NAGE and the second age WAGE. AM1 and the second age WAGE may form a second accumulation map AM2. In addition, the first adjusted deterioration amount (NDEGI in FIG. 7A) and the second adjusted deterioration amount (WDEGI in FIG. 7A) or the first deterioration amount (NDEG in FIG. 7B) and the second deterioration amount (WDEG in FIG. 7B) may form a first compensation map CM1.

In the present embodiment, the flag signal NF does not pass through a path of the input and output data of the deterioration compensator 644E so that the deterioration compensator 644E may not apply the compensation values to the viewing angle control pixels and the normal pixels respectively. In other words, the flag signal NF does not interact with the input or output data path of the deterioration compensator 644E, so the deterioration compensator 644E does not apply separate compensation values to the viewing angle control pixels and normal pixels.

Instead, the deterioration compensator 644E may compensate the input image data IMG differently according to the operation mode.

In a normal mode, the deterioration compensator 644E may compensate the input image data IMG corresponding to the viewing angle control pixels and the input image data IMG corresponding to the normal pixel by combining the first age NAGE and the second age WAGE.

For example, in the normal mode, the deterioration compensator 644E may compensate the input image data IMG corresponding to the viewing angle control pixels and the input image data IMG corresponding to the normal pixel based on an average value of the first age NAGE and the second age WAGE.

For example, in the normal mode, the deterioration compensator 644E may compensate the input image data IMG corresponding to the viewing angle control pixels and the input image data IMG corresponding to the normal pixel based on a weighted average value of the first age NAGE and the second age WAGE.

In the normal mode, the first compensation map CM1 of FIG. 13C may be generated using the first accumulation map AM1 of FIG. 13A and the second accumulation map AM2 of FIG. 13B.

The first accumulation map AM1 of FIG. 13A may have first accumulation values N11 to N64 corresponding to display blocks. The second accumulation map AM2 of FIG. 13B may have second accumulation values W11 to W64 corresponding to the display blocks. The first compensation map CM1 of FIG. 13C may have compensation values C11 to C64 corresponding to the display blocks.

Although the display panel 100 includes the display blocks disposed in six rows and four columns in FIGS. 13A to 13C, the present inventive concept may not be limited to the number of the display blocks.

In contrast, in a private mode, the deterioration compensator 644E may compensate the input image data IMG corresponding to the viewing angle control pixels using the first age NAGE.

In the present embodiment, detailed structures of the stress accumulator 642 and the deterioration compensator 644E may be substantially the same as detailed structures of the stress accumulator 242 and the deterioration compensator 244 explained referring to FIGS. 7A and 7B.

According to the present embodiment, stress accumulation and deterioration compensation are independently applied to the viewing angle control pixels and normal pixels, helping to prevent display quality degradation resulting from differences in their deterioration levels.

Improving the accuracy in determining the deterioration levels of both the viewing angle control pixels and normal pixels further enhances the display quality of the display panel 100.

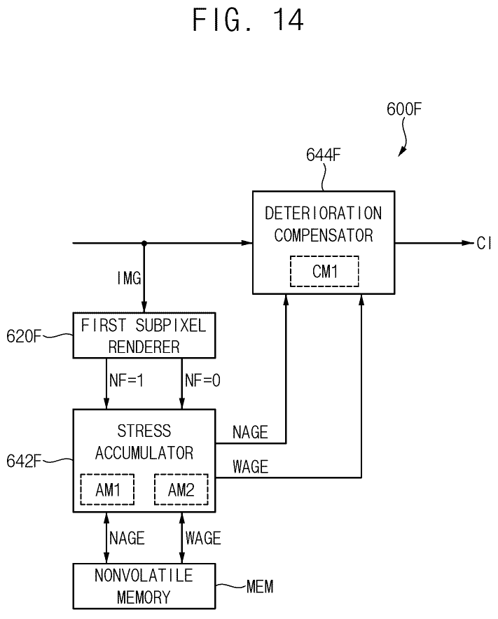

FIG. 14 is a block diagram illustrating a host 600F and a nonvolatile memory MEM of a display apparatus according to an embodiment of the present inventive concept.

The display apparatus according to the present embodiment is substantially the same as the display apparatus of the previous embodiment explained referring to FIGS. 12 to 13C except that the stress accumulator does not accumulate the stress of the input image data but instead accumulates the stress of the rendered image data. Thus, the same reference numerals will be used to refer to the same or like parts as those described in the previous embodiment of FIGS. 12 to 13C and any repetitive explanation concerning the above elements will be omitted.

Referring to FIGS. 1 to 4, 7A, 7B, 13A, 13B, 13C and 14, the display apparatus includes a display panel 100, a data driver 500, a driving controller 200C and a host 600F.

In the present embodiment, the host 600F may include a first subpixel renderer 620F for rendering input image data IMG to the viewing angle control pixel and the normal pixel according to an operation mode and outputting rendered image data and a flag signal NF to the afterimage compensator (e.g. the stress accumulator 642F).

In the present embodiment, the afterimage compensator may include a deterioration compensator 644F for compensating the input image data IMG according to the operation mode and outputting the deterioration compensation image data CI and a stress accumulator 642F for accumulating the first stress NSTR of the input image data IMG corresponding to the viewing angle control pixel to generate the first age NAGE when the flag signal NF has a first value (e.g. NF=1) and accumulating the second stress WSTR of the input image data IMG corresponding to the normal pixel to generate the second age WAGE when the flag signal NF has a second value (e.g. NF=0).

In the present embodiment, the deterioration compensator 644F may compensate the input image data IMG corresponding to the viewing angle control pixel and the input image data IMG corresponding to the normal pixel based on the first age NAGE and the second age WAGE.

In the present embodiment, the first age NAGE may form a first accumulation map AM1 and the second age WAGE may form a second accumulation map AM2. In addition, the first adjusted deterioration amount (NDEGI in FIG. 7A) and the second adjusted deterioration amount (WDEGI in FIG. 7A) or the first deterioration amount (NDEG in FIG. 7B) and the second deterioration amount (WDEG in FIG. 7B) may form a first compensation map CM1.

In the present embodiment, the flag signal NF does not pass through a path of the input and output data of the deterioration compensator 644F so that the deterioration compensator 644F may not apply the compensation values to the viewing angle control pixels and the normal pixels respectively. In other words, the flag signal NF does not interact with the input or output data path of the deterioration compensator 644F, preventing it from applying separate compensation values to the viewing angle control pixels and normal pixels.

Instead, the deterioration compensator 644F may compensate the input image data IMG based on the operation mode.

In a normal mode, the deterioration compensator 644F may compensate the input image data IMG corresponding to the viewing angle control pixels and the input image data IMG corresponding to the normal pixel by combining the first age NAGE and the second age WAGE. In contrast, in a private mode, the deterioration compensator 644F may compensate the input image data IMG corresponding to the viewing angle control pixels using the first age NAGE.

In the present embodiment, detailed structures of the stress accumulator 642F and the deterioration compensator 644F may be substantially the same as detailed structures of the stress accumulator 242 and the deterioration compensator 244 explained referring to FIGS. 7A and 7B.

According to the present embodiment, stress accumulation and deterioration compensation are independently applied to the viewing angle control pixels and normal pixels, helping to prevent display quality degradation resulting from differences in their deterioration levels.

Improving the accuracy in determining the deterioration levels of both the viewing angle control pixels and normal pixels further enhances the display quality of the display panel 100.

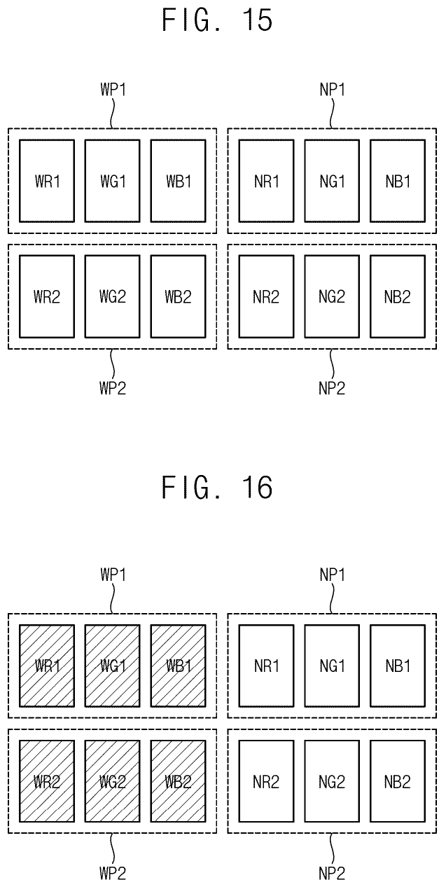

FIG. 15 is a diagram illustrating pixels of a display panel of a display apparatus according to an embodiment of the present inventive concept in a normal mode. FIG. 16 is a diagram illustrating pixels of the display panel of FIG. 15 in a private mode.

The display apparatus according to the present embodiment is substantially the same as the display apparatus of the previous embodiment explained referring to FIGS. 1 to 7B except for the pixel structure of the display panel. Thus, the same reference numerals will be used to refer to the same or like parts as those described in the previous embodiment of FIGS. 1 to 7B and any repetitive explanation concerning the above elements will be omitted.

Referring to FIGS. 1, 4 to 7B, 15 and 16, the display panel 100 may include a normal pixel and a viewing angle control pixel (e.g., a private pixel). The viewing angle control pixel may be the private pixel for a private mode. The normal pixel may be referred to as a wide pixel. The viewing angle control pixel may be referred to as a narrow pixel.

As shown in FIG. 4, in the private mode PRIVATE MODE, only the viewing angle control pixels NARROW PIXELs emit light, the normal pixels WIDE PIXELs remain off. This allows the image of the display panel 100 to be clearly visible from the front, but obscured from the side, protecting the user's privacy. In contrast, in the normal mode NORMAL MODE, the viewing angle control pixels NARROW PIXELs and the normal pixels WIDE PIXELs may emit light.

The display panel 100 may include a first color first normal pixel WR1, a second color first normal pixel WG1, a third color first normal pixel WB1, a first color first viewing angle control pixel NR1, a second color first viewing angle control pixel NG1 and a third color first viewing angle control pixel NB1 sequentially disposed in a first row and a first color second normal pixel WR2, a second color second normal pixel WG2, a third color second normal pixel WB2, a first color second viewing angle control pixel NR2, a second color second viewing angle control pixel NG2 and a third color second viewing angle control pixel NB2 sequentially disposed in a second row.

Herein, the first color is red, the second color is green and the third color is blue.

In FIGS. 15 and 16, the normal pixel refers to a light emitting area of the normal pixel and the viewing angle control pixel refers to a light emitting area of the viewing angle control pixel.

For example, WR1, WG1 and WB1 may be disposed in a rectangular shape. WR1, WG1 and WB1 may be one unit pixel group (a normal pixel group WP1). For example, NR1, NG1 and NB1 may be disposed in a rectangular shape. NR1, NG1 and NB1 may be one unit pixel group (a viewing angle control pixel group NP1). For example, WR2, WG2 and WB2 may be disposed in a rectangular shape. WR2, WG2 and WB2 may be one unit pixel group (a normal pixel group WP2). For example, NR2, NG2 and NB2 may be disposed in a rectangular shape. NR2, NG2 and NB2 may be one unit pixel group (a viewing angle control pixel group NP2).

In the normal mode, the first color first normal pixel WR1, the second color first normal pixel WG1, the third color first normal pixel WB1, the first color second normal pixel WR2, the second color second normal pixel WG2 and the third color second normal pixel WB2 may emit light. In the normal mode, the first color first viewing angle control pixel NR1, the second color first viewing angle control pixel NG1, the third color first viewing angle control pixel NB1, the first color second viewing angle control pixel NR2, the second color second viewing angle control pixel NG2 and the third color second viewing angle control pixel NB2 may emit light.

In the private mode, the first color first normal pixel WR1, the second color first normal pixel WG1, the third color first normal pixel WB1, the first color second normal pixel WR2, the second color second normal pixel WG2 and the third color second normal pixel WB2 may not emit light. In other words, the first color first normal pixel WR1, the second color first normal pixel WG1, the third color first normal pixel WB1, the first color second normal pixel WR2, the second color second normal pixel WG2 and the third color second normal pixel WB2 may be turned-off. In the private mode, the first color first viewing angle control pixel NR1, the second color first viewing angle control pixel NG1, the third color first viewing angle control pixel NB1, the first color second viewing angle control pixel NR2, the second color second viewing angle control pixel NG2 and the third color second viewing angle control pixel NB2 may emit light.

The driving controller 200 may include a subpixel renderer 220 for rendering the input image data IMG to the viewing angle control pixel and the normal pixel according to an operation mode and an afterimage compensator 240 for accumulating a first stress NSTR corresponding to the viewing angle control pixel to generate a first age NAGE of the viewing angle control pixel, accumulating a second stress WSTR corresponding to the normal pixel to generate a second age WAGE of the normal pixel, compensating data of the viewing angle control pixel based on the first age NAGE and compensating data of the normal pixel based on the second age WAGE.

According to the present embodiment, stress accumulation and deterioration compensation are independently applied to the viewing angle control pixels and normal pixels, helping to prevent display quality degradation resulting from differences in their deterioration levels.

Improving the accuracy in determining the deterioration levels of both the viewing angle control pixels and normal pixels further enhances the display quality of the display panel 100.

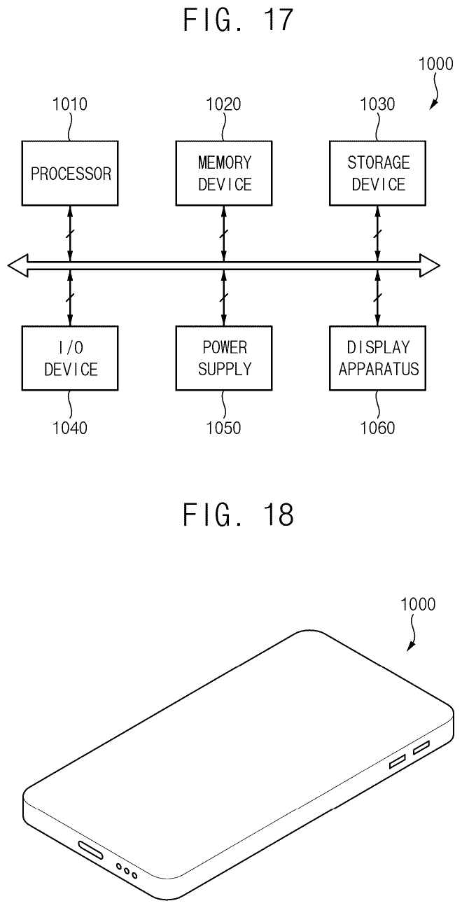

FIG. 17 is a block diagram illustrating an electronic apparatus 1000 according to an embodiment of the present inventive concept. FIG. 18 is a diagram illustrating an example in which the electronic apparatus 1000 of FIG. 17 is implemented as a smartphone

Referring to FIGS. 17 and 18, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 18, the electronic apparatus 1000 may be implemented as a smartphone. However, the electronic apparatus 1000 is not limited thereto. For example, the electronic apparatus 1000 may be implemented as a television, a monitor, a cellular phone, a video phone, a smart pad, a smart watch, a tablet personal computer (PC), a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1. The processor 1010 may be the host 600 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

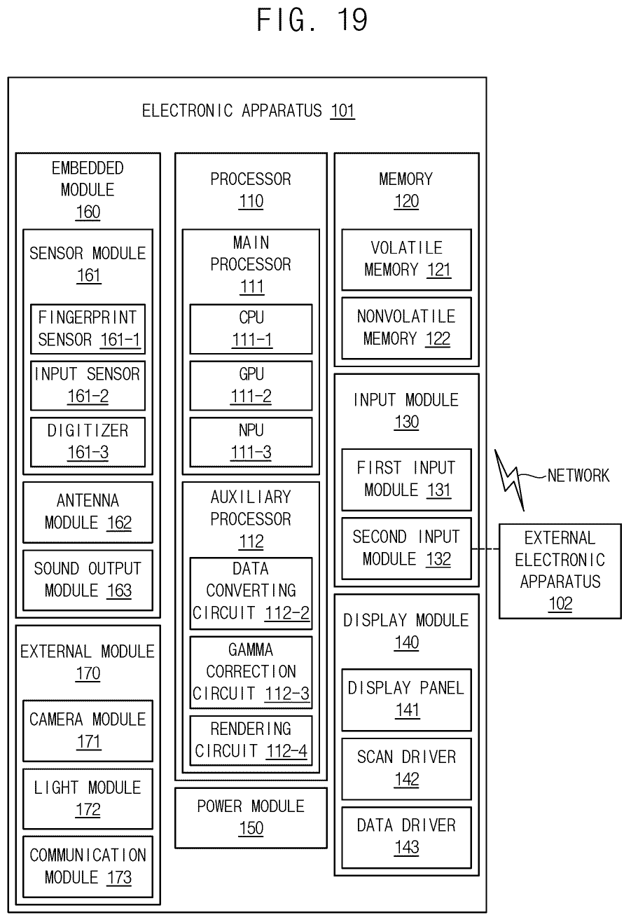

FIG. 19 is a block diagram illustrating an electronic apparatus 101 according to an embodiment of the present inventive concept.

Referring to FIGS. 1 to 19, an electronic apparatus 101 outputs various information through a display module 140 in an operating system. When a processor 110 executes an application stored in a memory 120, the display module 140 provides application information to a user through a display panel 141.

The processor 110 obtains an external input through an input module 130 or a sensor module 161 and executes an application corresponding to the external input. For example, when the user selects a camera icon displayed on the display panel 141, the processor 110 obtains a user input through an input sensor 161-2 and activates a camera module 171. The processor 110 transfers image data corresponding to a captured image obtained through the camera module 171 to the display module 140. The display module 140 may display an image corresponding to the captured image through the display panel 141.

In an embodiment, when personal information authentication is performed in the display module 140, a fingerprint sensor 161-1 obtains input fingerprint information as input data. The processor 110 compares input data obtained through the fingerprint sensor 161-1 with authentication data stored in the memory 120, and executes an application according to a comparison result. The display module 140 may display information executed according to application logic through the display panel 141.

In an embodiment, when a music streaming icon displayed on the display module 140 is selected, the processor 110 receives user input through the input sensor 161-2 and activates a music streaming application stored in the memory 120. When a music execution command is input in the music streaming application, the processor 110 activates a sound output module 163 to provide sound information corresponding to the music execution command to the user.

In the above, the operation of the electronic apparatus 101 is briefly described. Hereinafter, a configuration of the electronic apparatus 101 is described in detail. Some of elements of the electronic apparatus 101 described later may be integrated and provided as one element, or one element may be separated as two or more elements.

The electronic apparatus 101 may communicate with an external electronic apparatus 102 through a network (e.g., a short-range wireless communication network or a long-range wireless communication network). According to an embodiment, the electronic apparatus 101 may include the processor 110, the memory 120, the input module 130, the display module 140, a power module 150, an embedded module 160, and an external module 170. According to an embodiment, in the electronic apparatus 101, at least one of the above-described elements may be omitted or one or more other apparatus may be added. According to an embodiment, some of the above-described elements (e.g., the sensor module 161, an antenna module 162 or the sound output module 163) may be integrated into another element (e.g., the display module 140).

The processor 110 may execute software to control at least one other element (e.g., a hardware or software element) of the electronic apparatus 101 connected to the processor 110 and to perform various data processing or operations. According to an embodiment, as at least part of the data processing or the operations, the processor 110 may store receive instructions or data from other elements (e.g., the input module 130, the sensor module 161 or a communication module 173) in a volatile memory 121, may process the instructions or data stored in the volatile memory 121 and may store result data of the processing in a nonvolatile memory 122.

The processor 110 may include a main processor 111 and an auxiliary processor 112. The main processor 111 may include at least one of a central processing unit (CPU) 111-1 and an application processor (AP). The main processor 111 may further include any one or more of a graphic processing unit (GPU) 111-2, a communication processor (CP) and an image signal processor (ISP). The main processor 111 may further include a neural processing unit (NPU) 111-3. The neural network processing unit 111-3 is a processor specialized in processing an artificial intelligence model. The artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN) and a deep Q-network or a combination of two or more of the above. However, the artificial neural network is not limited to the above examples. The artificial intelligence model may include software structures, in addition to hardware structures or instead of the hardware structures. At least two of the above-described processing units and the above-described processors may be implemented as an integrated element (e.g., as a single chip) or each may be implemented as independent elements (e.g., in a plurality of chips).

The auxiliary processor 112 may include a controller. The controller may include an interface conversion circuit and a timing control circuit. The controller receives an image signal from the main processor 111, converts a data format of the image signal to meet interface specifications with the display module 140, and outputs image data. The controller may output various control signals for driving the display module 140.

The auxiliary processor 112 may further include a data converting circuit 112-2, a gamma correction circuit 112-3 and a rendering circuit 112-4. The data converting circuit 112-2 may receive the image data from the controller and adjust it to display the image at the desired luminance based on the characteristics of the electronic apparatus 101 or a user setting. The data converting circuit 112-2 may also convert the image data to reduce power consumption or compensate for afterimages. The gamma correction circuit 112-3 may convert the image data or a gamma reference voltage such that the image displayed on the electronic apparatus 101 has desired gamma characteristics. The rendering circuit 112-4 may receive the image data from the controller and may render the image data based on a pixel arrangement of the display panel 141 included in the electronic apparatus 101. At least one of the data converting circuit 112-2, the gamma correction circuit 112-3 and the rendering circuit 112-4 may be integrated into another element (e.g., the main processor 111 or the controller). At least one of the data converting circuit 112-2, the gamma correction circuit 112-3 and the rendering circuit 112-4 may be integrated into a data driver 143 to be described later.

The memory 120 may store various data used by at least one element (e.g., the processor 110 or the sensor module 161) of the electronic apparatus 101 and input data or output data for commands related thereto. The memory 120 may include at least one of the volatile memory 121 and the nonvolatile memory 122.

The input module 130 may receive commands or data used to the elements (e.g., the processor 110, the sensor module 161 or the sound output module 163) of the electronic apparatus 101 from the outside of the electronic apparatus 101 (e.g., the user or the external electronic apparatus 102).

The input module 130 may include a first input module 131 for receiving commands or data from the user and a second input module 132 for receiving commands or data from the external electronic apparatus 102. The first input module 131 may include a microphone, a mouse, a keyboard, a key (e.g., a button) or a pen (e.g., a passive pen or an active pen). The second input module 132 may support a designated protocol that enables wired and wireless connection to the external electronic apparatus 102. According to an embodiment, the second input module 132 may include a high definition multimedia interface (HDMI), a universal serial bus (USB) interface, an SD card interface or an audio interface. The second input module 132 may include a connector physically connected to the external electronic apparatus 102, for example, an HDMI connector, a USB connector, an SD card connector, or an audio connector (e.g., a headphone connector).

The display module 140 visually provides information to the user. The display module 140 may include the display panel 141, a scan driver 142 and the data driver 143. The display module 140 may further include a window, a chassis and a bracket to protect the display panel 141.

The display panel 141 may include a liquid crystal display panel, an organic light emitting display panel or an inorganic light emitting display panel. A type of the display panel 141 is not particularly limited. The display panel 141 may be a rigid type or a flexible type capable of being rolled or folded. The display module 140 may further include a supporter or a heat dissipation member supporting the display panel 141.

The scan driver 142 may be mounted on the display panel 141 as a driving chip. Alternatively, the scan driver 142 may be integrated on the display panel 141. For example, the scan driver 142 may include an amorphous silicon thin film transistor (TFT) gate driver circuit (ASG) integrated on the display panel 141, a low temperature polycrystalline silicon (LTPS) TFT gate driver circuit integrated on the display panel 141, or an oxide semiconductor TFT gate driver circuit (OSG) integrated on the display panel 141. The scan driver 142 receives a control signal from the controller and outputs the scan signals to the display panel 141 in response to the control signal.

The display module 140 may further include a light emission driver. The light emission driver outputs a light emission control signal to the display panel 141 in response to a control signal received from the controller. The light emission driver may be formed independently from the scan driver 142. Alternatively, the light emission driver and the scan driver 142 may be integrally formed.

The data driver 143 receives a control signal from the controller and converts the image data into an analog voltage (e.g., the data voltage) and outputs the data voltages to the display panel 141 in response to the control signal.

The data driver 143 may be integrated into another element (e.g., the controller). The functions of the interface conversion circuit and the timing control circuit of the controller described above may be integrated into the data driver 143.

The display module 140 may further include a voltage generating circuit. The voltage generating circuit may output various voltages for driving the display panel 141.

The power module 150 supplies power to elements of the electronic apparatus 101. The power module 150 may include a battery which supplies a power voltage. The battery may include a non-rechargeable primary cell, a rechargeable secondary cell or a fuel cell. The power module 150 may include a power management integrated circuit (PMIC). The PMIC supplies optimized power to each of the above-described modules and modules described later. The power module 150 may include a wireless power transmission/reception member electrically connected to the battery. The wireless power transmission/reception member may include a plurality of antenna radiators in a form of coils.

The electronic apparatus 101 may further include the embedded module 160 and the external module 170. The embedded module 160 may include the sensor module 161, the antenna module 162 and the sound output module 163. The external module 170 may include the camera module 171, a light module 172 and the communication module 173.

The sensor module 161 may detect an input by a user's body or an input by the pen among the first input module 131, and generate an electrical signal or data value corresponding to the input. The sensor module 161 may include at least one of the fingerprint sensor 161-1, the input sensor 161-2 and a digitizer 161-3.

The fingerprint sensor 161-1 may generate a data value corresponding to a user's fingerprint. The fingerprint sensor 161-1 may include one of an optical fingerprint sensor or a capacitive fingerprint sensor.

The input sensor 161-2 may generate data values corresponding to coordinate information of the input by the user's body or the input by the pen. The input sensor 161-2 generates a capacitance change due to an input as a data value. The input sensor 161-2 may detect an input by the passive pen or transmit/receive data to/from the active pen.

The input sensor 161-2 may measure bio signals such as a blood pressure, a moisture, or a body fat. For example, when a user touches a part of his body to a sensor layer or a sensing panel and does not move for a certain period of time, the input sensor 161-2 may detect the bio signal based on a change in an electric field caused by the part of the body so that the display module 140 may output user's desired information.

The digitizer 161-3 may generate a data value corresponding to the coordinate information input by the pen. The digitizer 161-3 generates an amount of electromagnetic change by the input as a data value. The digitizer 161-3 may detect an input by the passive pen or transmit/receive data to/from the active pen.

At least one of the fingerprint sensor 161-1, the input sensor 161-2 and the digitizer 161-3 may be formed as a sensor layer on the display panel 141 through a continuous process. The fingerprint sensor 161-1, the input sensor 161-2 and the digitizer 161-3 may be disposed on the display panel 141. At least one of the fingerprint sensor 161-1, the input sensor 161-2 and the digitizer 161-3, for example, the digitizer 161-3, may be disposed under the display panel 141.

At least two or more of the fingerprint sensor 161-1, the input sensor 161-2 and the digitizer 161-3 may be integrated into the sensing panel through the same process. When at least two or more of the fingerprint sensor 161-1, the input sensor 161-2 and the digitizer 161-3 are integrated into the sensing panel, the sensing panel may be disposed between the display panel 141 and a window disposed over an upper surface of the display panel 141. According to an embodiment, the sensing panel may be disposed on the window. The present inventive concept may not be limited to a position of the sensing panel.

At least one of the fingerprint sensor 161-1, the input sensor 161-2 and the digitizer 161-3 may be embedded in the display panel 141. For example, at least one of the fingerprint sensor 161-1, the input sensor 161-2 and the digitizer 161-3 is formed simultaneously with the display panel 141 through a process of forming elements included in the display panel 141 (e.g. light emitting elements, transistors, etc.).

In addition, the sensor module 161 may generate an electrical signal or a data value corresponding to an internal state or an external state of the electronic apparatus 101. For example, the sensor module 161 may further include a gesture sensor, a gyro sensor, a barometric pressure sensor, a magnetic sensor, an acceleration sensor, a grip sensor, a proximity sensor, a color sensor, an IR (infrared) sensor, a biosensor, a temperature sensor, a humidity sensor or an illuminance sensor.

The antenna module 162 may include one or more antennas for transmitting a signal or power to outside or receiving a signal or power from outside. According to an embodiment, the communication module 173 may use an appropriate antenna to transmit signals to, or receive signals from, an external electronic apparatus based on the selected communication method. An antenna pattern of the antenna module 162 may be integrated with an element of the display module 140 (e.g., the display panel 141) or the input sensor 161-2.

The sound output module 163 is a device for outputting sound signals to the outside of the electronic apparatus 101. For example, the sound output module 163 may include a speaker used for general purposes such as playing multimedia or recording and a receiver used exclusively for receiving a call. According to an embodiment, the receiver may be formed integrally with or separately from the speaker. A sound output pattern of the sound output module 163 may be integrated with the display module 140.

The camera module 171 may capture still images and moving images. According to an embodiment, the camera module 171 may include one or more lenses, an image sensor or an image signal processor. The camera module 171 may further include an infrared camera capable of determining a presence or an absence of a user, the user's location and the user's gaze.

The light module 172 may provide a light. The light module 172 may include a light emitting diode or a xenon lamp. The light module 172 may operate in conjunction with the camera module 171 or operate independently.

The communication module 173 may enable the establishment of a wired or wireless communication channel between the electronic apparatus 101 and the external electronic apparatus 102, facilitating communication over the established communication channel. The communication module 173 may include one or both of a wireless communication module such as a cellular communication module, a short-distance wireless communication module, or a global navigation satellite system (GNSS) communication module and a wired communication module such as a local area network (LAN) communication module, or a power line communication module. The communication module 173 may communicate with the external electronic apparatus 102 through a short-range communication network such as Bluetooth, WiFi direct or infrared data association (IrDA) or a long-distance communication network such as a cellular network, the Internet, or a computer network (e.g. LAN or WAN). The various types of communication modules 173 described above may be implemented as a single chip or may be implemented as separate chips.

The input module 130, the sensor module 161 and the camera module 171 may be used to control the operation of the display module 140 in conjunction with the processor 110.

The processor 110 outputs commands or data to the display module 140, the sound output module 163, the camera module 171 or the light module 172 based on the input data received from the input module 130. For example, the processor 110 may generate image data corresponding to input data applied through a mouse or an active pen, and output the generated image data to the display module 140 or the processor 110 may generate command data corresponding to the input data and output the generated command data to the camera module 171 or the light module 172. When input data is not received from the input module 130 for a certain period of time, the processor 110 converts an operation mode of the electronic apparatus 101 into a low power mode or a sleep mode so that power consumption of the electronic apparatus 101 may be reduced.

The processor 110 outputs commands or data to the display module 140, the sound output module 163, the camera module 171 or the light module 172 based on sensed data received from the sensor module 161. For example, the processor 110 may compare authentication data applied by the fingerprint sensor 161-1 with authentication data stored in the memory 120, and then execute an application according to the comparison result. The processor 110 may execute commands or output corresponding image data to the display module 140 based on the sensed data sensed by the input sensor 161-2 or the digitizer 161-3. When the sensor module 161 includes a temperature sensor, the processor 110 may receive temperature data for the temperature measured from the sensor module 161 and may further perform luminance correction on the image data based on the temperature data.

The processor 110 may receive data from the camera module 171 indicating the presence or the absence of the user, the user's location and their gaze direction. The processor 110 may further perform luminance correction on the image data based on the received data. For example, the processor 110, which determines the presence or the absence of the user through an input from the camera module 171, may display image data having the luminance corrected by the data converting circuit 112-2 or the gamma correction circuit 112-3 to the display module 140.

Some of the above elements may be interconnected using communication methods for peripheral devices such as a bus, a general purpose input/output (GPIO), a serial peripheral interface (SPI), a mobile industry processor interface (MIPI), or a ultra path interconnect (UPI) link, to exchange signals (e.g., commands or data) with each other. The processor 110 may communicate with the display module 140 through an agreed interface. For example, the processor 110 may communicate with the display module 140 through any one of the above communication methods. The present inventive concept may not be limited to the above communication methods.

The electronic apparatus 101 according to various embodiments disclosed herein, may encompass different types of apparatuses. For example, the electronic apparatus 101 may include at least one of a monitor, a portable communication apparatus (e.g., a smart phone), a computer apparatus, a portable multimedia apparatus, a portable medical apparatus, a camera, a wearable device and a home appliance. The electronic apparatus 101 according to the embodiment of the disclosure may not be limited to the aforementioned apparatuses.

For example, the display panel 100 of FIG. 1 may correspond to the display panel 141 of FIG. 19. For example, the driving controller 200 of FIG. 1 may correspond to the controller of the auxiliary processor 112 of FIG. 19. For example, the gate driver 300 of FIG. 1 may correspond to the scan driver 142 of FIG. 19. For example, the data driver 500 of FIG. 1 may correspond to the data driver 143 of FIG. 19.

According to the embodiments of the display apparatus, the electronic apparatus including the display apparatus and the method of driving the display panel using the display apparatus, the display quality of the display panel may be enhanced.

The foregoing is illustrative of the present inventive concept and should not be considered limiting. Although a few embodiments of the present inventive concept have been described, those skilled in the art will readily appreciate that many modifications can be made without departing from the novel teachings of the present inventive concept. Accordingly, all such modifications are intended to be included within the scope of the present inventive concept as set forth in the claims.

What is claimed is:

1. A display apparatus comprising:
a display panel including a viewing angle control pixel and a normal pixel;
a data driver configured to output a data voltage to the display panel; and
a driving controller configured to control the data driver,
wherein the driving controller comprises:
a subpixel renderer configured to render input image data to the viewing angle control pixel and the normal pixel according to an operation mode; and
an afterimage compensator configured to accumulate a first stress corresponding to the viewing angle control pixel to generate a first age of the viewing angle control pixel, accumulate a second stress corresponding to the normal pixel to generate a second age of the normal pixel, compensate data for the viewing angle control pixel based on the first age and compensate data for the normal pixel based on the second age.

2. The display apparatus of claim 1, wherein the afterimage compensator comprises:
a deterioration compensator configured to receive rendered image data and a flag signal from the subpixel renderer and output a deterioration compensation image data and the flag signal; and
a stress accumulator configured to accumulate the first stress of the deterioration compensation image data for the viewing angle control pixel to generate the first age when the flag signal has a first value and accumulate the second stress of the deterioration compensation image data for the normal pixel to generate the second age when the flag signal has a second value, and
wherein the deterioration compensator is configured to compensate the rendered image data for the viewing angle control pixel based on the first age and compensate the rendered image data for the normal pixel based on the second age.

3. The display apparatus of claim 2, wherein the stress accumulator comprises:
a first stress encoder configured to generate the first stress from the deterioration compensation image data for the viewing angle control pixel when the flag signal has the first value;
a first stress accumulator configured to accumulate the first stress to a previous first age to generate a current first age when the flag signal has the first value;
a second stress encoder configured to generate the second stress from the deterioration compensation image data for the normal pixel when the flag signal has the second value;
a second stress accumulator configured to accumulate the second stress to a previous second age to generate a current second age when the flag signal has the second value; and
a stress memory configured to output the previous first age to the first stress accumulator, receive the current first age from the first stress accumulator, output the previous second age to the second stress accumulator and receive the current second age from the second stress accumulator.

4. The display apparatus of claim 3, further comprising a nonvolatile memory configured to output the first age and the second age to the stress memory and receive the first age and the second age from the stress memory.

5. The display apparatus of claim 3, wherein the deterioration compensator comprises:
a first deterioration amount calculator configured to receive the first age from the stress memory and calculate a first deterioration amount based on the first age;
a first block interpolator configured to adjust the first deterioration amount using a first adjacent block deterioration amount of adjacent blocks to generate a first adjusted deterioration amount;
a second deterioration amount calculator configured to receive the second age from the stress memory and calculate a second deterioration amount based on the second age;
a second block interpolator configured to adjust the second deterioration amount using a second adjacent block deterioration amount of the adjacent blocks to generate a second adjusted deterioration amount; and
a compensator configured to compensate the rendered image data for the viewing angle control pixel based on the first adjusted deterioration amount and compensate the rendered image data for the normal pixel based on the second adjusted deterioration amount.

6. The display apparatus of claim 5, wherein the first stress, the second stress, the first age, the second age, the first deterioration amount, the second deterioration amount, the first adjusted deterioration amount and the second adjusted deterioration amount are generated in a unit of a block.

7. The display apparatus of claim 3, wherein the deterioration compensator comprises:
a first deterioration amount calculator configured to receive the first age from the stress memory and calculate a first deterioration amount based on the first age;
a second deterioration amount calculator configured to receive the second age from the stress memory and calculate a second deterioration amount based on the second age; and
a compensator configured to compensate the rendered image data for the viewing angle control pixel based on the first deterioration amount and compensate the rendered image data for the normal pixel based on the second deterioration amount.

8. The display apparatus of claim 7, wherein the first stress, the second stress, the first age, the second age, the first deterioration amount and the second deterioration amount are generated in a unit of a pixel.

9. The display apparatus of claim 1, wherein the afterimage compensator comprises:
a deterioration compensator configured to receive rendered image data and a flag signal from the subpixel renderer and output deterioration compensation image data; and
a stress accumulator configured to accumulate the first stress of the rendered image data for the viewing angle control pixel to generate the first age when the flag signal has a first value and accumulate the second stress of the rendered image data for the normal pixel to generate the second age when the flag signal has a second value, and
wherein the deterioration compensator is configured to compensate the rendered image data for the viewing angle control pixel based on the first age and compensate the rendered image data for the normal pixel based on the second age.

10. The display apparatus of claim 1, wherein the display panel comprises:
a first color first normal pixel disposed in a first pixel row;
a second color 1-1 normal pixel and a second color 1-2 normal pixel sequentially disposed in a second pixel row;
a first color first viewing angle control pixel, a third color first normal pixel and a first color second viewing angle control pixel sequentially disposed in a third pixel row;
a second color 1-1 viewing angle control pixel, a second color 1-2 viewing angle control pixel, a second color 2-1 viewing angle control pixel and a second color 2-2 viewing angle control pixel sequentially disposed in a fourth pixel row;
a third color first viewing angle control pixel, a first color second normal pixel and a third color second viewing angle control pixel sequentially disposed in a fifth pixel row;
a second color 2-1 normal pixel and a second color 2-2 normal pixel sequentially disposed in a sixth pixel row; and
a third color second normal pixel disposed in a seventh pixel row.

11. The display apparatus of claim 10,
wherein, in a normal mode, the first color first normal pixel, the second color 1-1 normal pixel, the second color 1-2 normal pixel, the third color first normal pixel, the first color second normal pixel, the second color 2-1 normal pixel, the second color 2-2 normal pixel and the third color second normal pixel are configured to emit light,
wherein, in the normal mode, the first color first viewing angle control pixel, the second color 1-1 viewing angle control pixel, the second color 1-2 viewing angle control pixel, the third color first viewing angle control pixel, the first color second viewing angle control pixel, the second color 2-1 viewing angle control pixel, the second color 2-2 viewing angle control pixel and the third color second viewing angle control pixel are configured to emit light,
wherein, in a private mode, the first color first normal pixel, the second color 1-1 normal pixel, the second color 1-2 normal pixel, the third color first normal pixel, the first color second normal pixel, the second color 2-1 normal pixel, the second color 2-2 normal pixel and the third color second normal pixel are configured not to emit light, and
wherein, in the private mode, the first color first viewing angle control pixel, the second color 1-1 viewing angle control pixel, the second color 1-2 viewing angle control pixel, the third color first viewing angle control pixel, the first color second viewing angle control pixel, the second color 2-1 viewing angle control pixel, the second color 2-2 viewing angle control pixel and the third color second viewing angle control pixel are configured to emit light.

12. The display apparatus of claim 1, wherein the display panel comprises:
a first color first normal pixel, a second color first normal pixel, a third color first normal pixel, a first color first viewing angle control pixel, a second color first viewing angle control pixel and a third color first viewing angle control pixel sequentially disposed in a first row; and
a first color second normal pixel, a second color second normal pixel, a third color second normal pixel, a first color second viewing angle control pixel, a second color second viewing angle control pixel and a third color second viewing angle control pixel sequentially disposed in a second row.

13. The display apparatus of claim 12,
wherein, in a normal mode, the first color first normal pixel, the second color first normal pixel, the third color first normal pixel, the first color second normal pixel, the second color second normal pixel and the third color second normal pixel are configured to emit light,
wherein, in the normal mode, the first color first viewing angle control pixel, the second color first viewing angle control pixel, the third color first viewing angle control pixel, the first color second viewing angle control pixel, the second color second viewing angle control pixel and the third color second viewing angle control pixel are configured to emit light,
wherein, in a private mode, the first color first normal pixel, the second color first normal pixel, the third color first normal pixel, the first color second normal pixel, the second color second normal pixel and the third color second normal pixel are configured not to emit light, and
wherein, in the private mode, the first color first viewing angle control pixel, the second color first viewing angle control pixel, the third color first viewing angle control pixel, the first color second viewing angle control pixel, the second color second viewing angle control pixel and the third color second viewing angle control pixel are configured to emit light.

14. An electronic apparatus comprising:
a display panel including a viewing angle control pixel and a normal pixel;
a data driver circuit configured to output a data voltage to the display panel;
a driving controller circuit configured to control the data driver circuit; and
a host configured to output compensated input image data and an input control signal to the driving controller circuit,
wherein the host comprises an afterimage compensator circuit configured to accumulate a first stress for the viewing angle control pixel to generate a first age of the viewing angle control pixel, accumulate a second stress for the normal pixel to generate a second age of the normal pixel and compensate data of the viewing angle control pixel based on the first age and data of the normal pixel based on the second age to generate deterioration compensation image data.

15. The electronic apparatus of claim 14, wherein the host further comprises:
a first subpixel renderer circuit configured to render input image data to the viewing angle control pixel and the normal pixel according to an operation mode; and
an inverse subpixel renderer circuit configured to perform inverse subpixel rendering to the deterioration compensation image data to generate the compensated input image data, and
wherein the driving controller circuit comprises a second subpixel renderer circuit configured to render the compensated input image data to the viewing angle control pixel and the normal pixel according to the operation mode.

16. The electronic apparatus of claim 14, wherein the host further comprises a first subpixel renderer circuit configured to render input image data to the viewing angle control pixel and the normal pixel according to an operation mode and output rendered image data and a flag signal to the afterimage compensator circuit,
wherein the afterimage compensator circuit comprises:
a deterioration compensator circuit configured to receive the rendered image data and the flag signal from the first subpixel renderer circuit and output the deterioration compensation image data and the flag signal; and
a stress accumulator circuit configured to accumulate the first stress of the deterioration compensation image data for the viewing angle control pixel to generate the first age when the flag signal has a first value and accumulate the second stress of the deterioration compensation image data for the normal pixel to generate the second age when the flag signal has a second value, and
wherein the deterioration compensator circuit is configured to compensate the rendered image data for the viewing angle control pixel based on the first age and the rendered image data for the normal pixel based on the second age.

17. The electronic apparatus of claim 14, wherein the host further comprises a first subpixel renderer circuit configured to render input image data to the viewing angle control pixel and the normal pixel according to an operation mode and output rendered image data and a flag signal to the afterimage compensator circuit,
wherein the afterimage compensator circuit comprises:
a deterioration compensator circuit configured to receive the rendered image data and the flag signal from the first subpixel renderer circuit and output the deterioration compensation image data; and
a stress accumulator circuit configured to accumulate the first stress of the rendered image data for the viewing angle control pixel to generate the first age when the flag signal has a first value and accumulate the second stress of the rendered image data for the normal pixel to generate the second age when the flag signal has a second value, and
wherein the deterioration compensator circuit is configured to compensate the rendered image data for the viewing angle control pixel based on the first age and the rendered image data for the normal pixel based on the second age.

18. The electronic apparatus of claim 14, wherein the host further comprises a first subpixel renderer circuit configured to render the deterioration compensation image data to the viewing angle control pixel and the normal pixel according to an operation mode and output rendered image data and a flag signal to the afterimage compensator circuit,
wherein the afterimage compensator circuit comprises:
a deterioration compensator circuit configured to compensate the input image data according to the operation mode and output the deterioration compensation image data; and
a stress accumulator circuit configured to accumulate the first stress of the deterioration compensation image data for the viewing angle control pixel to generate the first age when the flag signal has a first value and accumulate the second stress of the deterioration compensation image data for the normal pixel to generate the second age when the flag signal has a second value.

19. The electronic apparatus of claim 18,
wherein, in a normal mode, the deterioration compensator circuit is configured to compensate the input image data for the viewing angle control pixel and the input image data for the normal pixel by combining the first age and the second age, and
wherein, in a private mode, the deterioration compensator circuit is configured to compensate the input image data for the viewing angle control pixel using the first age.

20. The electronic apparatus of claim 14, wherein the host further comprises a first subpixel renderer circuit configured to render input image data to the viewing angle control pixel and the normal pixel according to an operation mode and output rendered image data and a flag signal to the afterimage compensator circuit, and
wherein the afterimage compensator circuit comprises:
a deterioration compensator circuit configured to compensate the input image data according to the operation mode and output the deterioration compensation image data; and
a stress accumulator circuit configured to accumulate the first stress of the input image data for the viewing angle control pixel to generate the first age when the flag signal has a first value and accumulate the second stress of the input image data for the normal pixel to generate the second age when the flag signal has a second value.

21. A method of driving a display panel, the method comprising:
rendering input image data to a viewing angle control pixel of the display panel and a normal pixel of the display panel according to an operation mode;
accumulating a first stress associated with the viewing angle control pixel to generate a first age of the viewing angle control pixel;
accumulating a second stress associated with the normal pixel to generate a second age of the normal pixel;
compensating data of the viewing angle control pixel based on the first age; and
compensating data of the normal pixel based on the second age.

22. A smartphone, comprising:
a display apparatus, comprising:
a display panel including a viewing angle control pixel and a normal pixel;
a data driver configured to output a data voltage to the display panel; and
a driving controller configured to control the data driver, wherein the driving controller comprises:
a subpixel renderer configured to render input image data to the viewing angle control pixel and the normal pixel according to an operation mode; and
an afterimage compensator configured to: accumulate a first stress corresponding to the viewing angle control pixel to generate a first age of the viewing angle control pixel, accumulate a second stress corresponding to the normal pixel to generate a second age of the normal pixel, compensate data for the viewing angle control pixel based on the first age, and compensate data for the normal pixel based on the second age.
